(19) United States
(12) Patent Application Publication
(10) Pub. No.: US 2013/0080083 A1
(43) Pub. Date: Mar. 28, 2013

(54) SYSTEM AND METHOD FOR DETERMINING PHYSICAL PROPERTIES OF EXHAUST GAS PRODUCED BY AN INTERNAL COMBUSTION ENGINE

(71) Applicant: John N. Chi, Dubuque, IA (US)

(72) Inventor: John N. Chi, Dubuque, IA (US)

(21) Appl. No.: 13/244,557

(22) Filed: Sep. 25, 2011

(51) Int. Cl. G06F 19/00; G01F 1/74

(52) U.S. Cl. 702/50; 73/861.04

(57) ABSTRACT

At least one physical property of exhaust gas produced by a cylinder of an internal combustion engine may be determined by determining a temperature, T_{EOC}, a pressure, P_{EOC}, and a clearance volume, V_{EOC}, of the cylinder at an end of combustion of an engine cycle, determining a temperature T_{EVO}, a pressure, P_{EVO}, and a clearance volume, V_{EVO}, of the cylinder at an opening of an exhaust valve of the cylinder following the end of combustion of the engine cycle as a function of T_{EOC}, P_{EOC}, and V_{EOC}, determining a value of the at least one physical property of the exhaust gas produced by the cylinder during the engine cycle as a function of T_{EOC}, P_{EOC}, and V_{EOC}, and storing the value of the at least one physical property of the exhaust gas during the engine cycle in memory.

### FIELD OF THE INVENTION

The present invention relates generally to internal combustion engines, and more specifically to systems and methods for estimating one or more engine cylinder peak operating parameters during the operation of internal combustion engines.

### BACKGROUND

Internal combustion engines generally include one or more cylinders in which an air-fuel mixture is combusted, after which exhaust gases resulting from such combustion exit via an exhaust manifold. It is desirable to determine one or more operating parameters of such one or more engine cylinders during the operation of an internal combustion engine using information provided by actual and/or virtual on-board sensors other than physical engine cylinder operation sensors.

### SUMMARY

The present invention may comprise one or more of the features recited in the claims appended hereto, and/or one or more of the following features and combinations thereof. In one aspect, a method is provided for determining at least one physical property of exhaust gas produced by a cylinder of an internal combustion engine. The method may comprise determining a temperature, T_{EOC}, a pressure, P_{EOC}, and a clearance volume, V_{EOC}, of the cylinder at an end of combustion of an engine cycle, determining a temperature T_{EVO}, a pressure, P_{EVO}, and a clearance volume, V_{EVO}, of the cylinder at an opening of an exhaust valve of the cylinder following the end of combustion of the engine cycle as a function of T_{EOC}, P_{EOC}, and V_{EOC}, determining a value of the at least one physical property of the exhaust gas produced by the cylinder during the engine cycle as a function of T_{EOC}, P_{EOC}, and V_{EOC}, and storing the value of the at least one physical property of the exhaust gas during the engine cycle in memory.

In another aspect, a method is provided for determining at least one physical property of exhaust gas produced by a cylinder of an internal combustion engine. The method may comprise executing a combustion model that models changes in operating conditions of the cylinder throughout a combustion portion of an engine cycle, the combustion model estimating a temperature, T_{EOC}, and a pressure, P_{EOC}, of the cylinder at an end of the combustion portion of the engine cycle, executing an expansion model that models changes in operating conditions of the cylinder between the end of the combustion portion of the engine cycle and a point thereafter in the engine cycle at which an exhaust valve of the cylinder is opened, the expansion model estimating cylinder temperature, T_{EVO}, and cylinder pressure, P_{EVO}, when the exhaust valve of the cylinder is opened as a function of T_{EOC} and P_{EOC}, executing an exhaust blowdown model that models changes in operating conditions of the cylinder between the point in the engine cycle at which the exhaust valve of the cylinder is opened and a point thereafter in the engine cycle at which a piston reaches a bottom-dead-center position in the cylinder, the exhaust blowdown model estimating a value of the at least one physical property of the exhaust gas produced by a cylinder as a function of T_{EVO} and P_{EVO}, and storing the value of the at least one physical property of the exhaust gas produced by a cylinder in memory.

### BRIEF DESCRIPTION OF THE DRAWINGS

FIG. 1 is a diagram of one illustrative embodiment of a system for determining engine cylinder and exhaust manifold operating conditions.

FIG. 2 is a diagram illustrating an engine cylinder and exhaust manifold model logic block stored in the memory of, and executable by, the control circuit illustrated in FIG. 1.

FIG. 3 is a plot of cylinder pressure vs. cylinder volume illustrating pressure and volume conditions within a cylinder of an example engine over one complete engine cycle.

FIG. 4 is a diagram of one illustrative embodiment of the engine cylinder and exhaust manifold model logic block of FIG. 2.

FIG. 5 is a flowchart of one illustrative embodiment of the main control logic block of FIG. 4.

FIG. 6 is a diagram of one illustrative embodiment of the induction model logic block of FIG. 4.

FIG. 7 is a diagram of one illustrative embodiment of the compression model logic block of FIG. 4.

FIG. 8 is a diagram of one illustrative embodiment of the ignition delay model logic block of FIG. 4.

FIG. 9 is a flowchart of one illustrative embodiment of the combustion model logic block of FIG. 4.

FIG. 10 is a diagram of one illustrative embodiment of the expansion model logic block of FIG. 4.

FIG. 11 is a diagram of one illustrative embodiment of the exhaust blowdown model logic block of FIG. 4.

FIG. 12 is a plot of pressure-based exhaust blowdown efficiency vs. normalized turbocharger orifice outlet pressure showing one illustrative embodiment of the F6 logic block of FIG. 11.

FIG. 13 is a plot of temperature-based exhaust blowdown efficiency vs. normalized turbocharger orifice outlet pressure showing one illustrative embodiment of the F7 logic block of FIG. 11.

### DESCRIPTION OF THE ILLUSTRATIVE EMBODIMENTS

For the purposes of promoting an understanding of the principles of the invention, reference will now be made to a number of illustrative embodiments shown in the attached drawings and specific language will be used to describe the same.

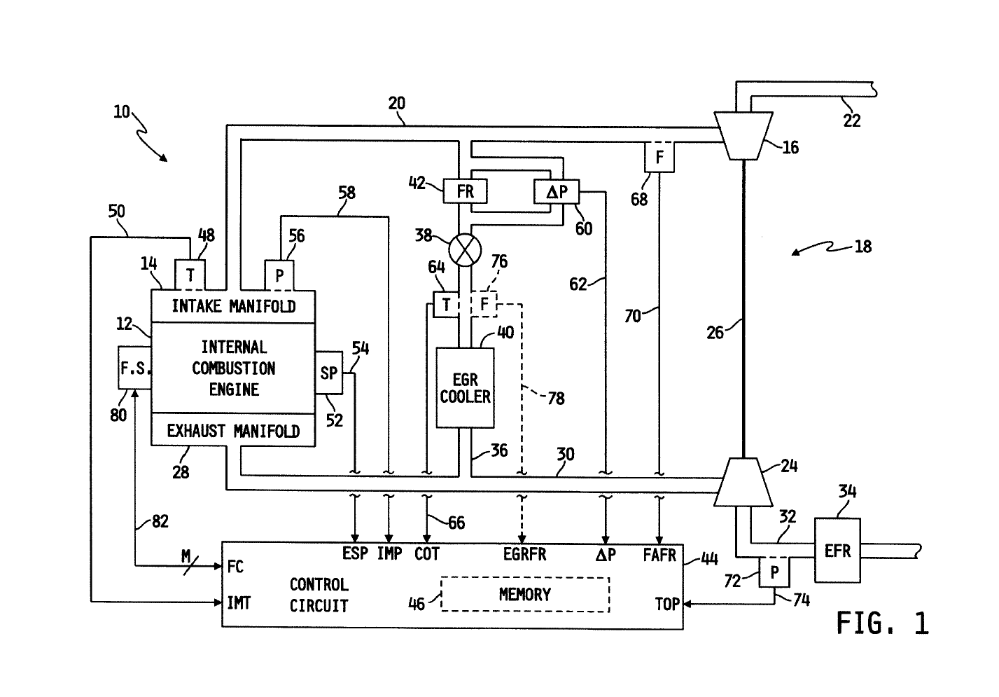

Referring now to FIG. 1, a diagrammatic illustration is shown of one illustrative embodiment of a system 10 for determining engine cylinder and exhaust manifold operating conditions. In the illustrated embodiment, the system 10 includes an internal combustion engine 12 having an intake manifold 14 that is fluidly coupled to an air outlet of a compressor 16 of a conventional turbocharger 18 via an air intake conduit 20. The compressor 16 further includes an air inlet coupled to an air intake conduit 22 for receiving fresh air. The turbocharger compressor 16 is conventional and includes a rotatable wheel (not shown) that is mechanically coupled to one end of a rotatable drive shaft 26 having an opposite end that is mechanically coupled to a rotatable wheel (not shown) of a turbocharger turbine 24. The turbine 24 is conventional and includes an exhaust inlet that is fluidly coupled to an exhaust manifold 28 of the engine 12 via an exhaust conduit 30. The turbine 24 further includes an exhaust outlet that is fluidly coupled to another exhaust conduit 32.

The turbocharger 18 operates in a conventional manner in which exhaust gas produced by the engine 12 and exiting the exhaust manifold 28 is directed through the turbine 24 causing the turbine wheel to rotate. This rotary motion is translated by the drive shaft 26 to the compressor wheel. The compressor wheel is configured in a conventional manner such that rotation of the compressor wheel by the drive shaft 26 draws more air through the air intake conduit 20 than would otherwise occur in the absence of the turbocharger 18.

In the illustrated embodiment, an exhaust flow restriction (EFR) device 34 is disposed in-line with the exhaust conduit 32 such that exhaust gas exiting the turbine 24 flows through the exhaust flow restriction device before reaching ambient. In one embodiment, the exhaust flow restriction device 34 is or includes one or more conventional exhaust gas aftertreatment devices, examples of which include, but should not be limited to, any one or more of an oxidation catalyst, a particulate filter, a NOx adsorber catalyst, or the like. Alternatively or additionally, the exhaust flow restriction device 34 may be or include a conventional valve or throttle that may be electronically controlled, e.g., by a suitable control circuit, to selectively restrict exhaust gas flow through the exhaust conduit 32. Alternatively or additionally, the exhaust flow restriction device may be or include a conventional mechanically controlled valve or throttle, or a fixed flow restriction, e.g., a conventional reduced orifice device or an area of the exhaust conduit 32 that has reduced cross-sectional flow area. It will be understood, however, that this disclosure contemplates embodiments that do not include an exhaust flow restriction device 34 and which the exhaust gas outlet of the turbine 24 instead is fluidly coupled directly to ambient via the exhaust conduit 32.

The system 10 further includes an exhaust gas recirculation (EGR) conduit 36 having one end that is fluidly coupled to the exhaust manifold 28, e.g., via the exhaust conduit 30, and an opposite end that is fluidly coupled to the intake manifold 14, e.g., via the intake conduit 20. In some embodiments, although not shown in the embodiment illustrated in FIG. 1, a conventional mixer may be included at the junction of the EGR conduit 36 and the intake conduit 20 for mixing of the exhaust gas flowing through the EGR conduit 36 and the fresh air supplied by the compressor 16.

In the illustrated embodiment, a conventional EGR cooler 40 is disposed in-line with the EGR conduit 36 and is configured to cool exhaust gas flowing through the cooler 40. In one embodiment, the cooler 40 is configured in a conventional manner to define a coolant fluid path therethrough (not shown). In this embodiment, a cooling fluid, such as engine coolant supplied by the engine 12, is supplied to a coolant inlet of the cooler 40, and engine coolant circulating through the cooler 40 is returned to the engine 12 via a fluid conduit that is fluidly coupled to a coolant outlet of the cooler 40. Alternatively or additionally, the EGR cooler 40 may be configured to cool exhaust gas flowing therethrough using other conventional heat exchanging mechanisms and/or techniques. In any case, the EGR cooler 40 defines an exhaust gas inlet at one end and an exhaust gas outlet at an opposite end thereof. In the illustrated embodiment, the exhaust gas inlet is fluidly coupled directly to the exhaust manifold 28 with no flow restrictions positioned therebetween in the exhaust conduit 30 or the EGR conduit 36. Accordingly, the exhaust gas pressure in the exhaust manifold 28 will be understood to be the same as that at the exhaust gas inlet of the EGR cooler 40. Illustratively, the EGR cooler 40 is positioned sufficiently close in proximity to the exhaust manifold 28 such that no significant temperature drop occurs in the exhaust gas exiting the exhaust manifold and that entering the EGR cooler 40. Accordingly, the temperature of the exhaust gas exiting the exhaust manifold 28 will be understood to be the same as the temperature of the exhaust gas entering the EGR cooler 40.

The system 10 further includes a conventional EGR valve 38 disposed in-line with the EGR conduit 36 between the exhaust gas outlet of the EGR cooler 40 and the junction of the EGR conduit 36 and the intake conduit 20. Although not shown in FIG. 1, the system 10 may in some embodiments include a conventional EGR valve position sensor configured to produce a signal corresponding to a position of the EGR valve 38 relative to a reference position, and a conventional EGR valve actuator configured to be responsive to a control signal to control the position of the EGR valve 38 relative to the reference position.

The system 10 further illustratively includes a conventional flow restriction 42 defined by the EGR conduit 36 or a conventional flow restriction device 42 disposed in-line with the EGR conduit 36. In either case, the flow restriction 42 may be positioned between the EGR valve 38 and the intake conduit 20 in embodiments that include the EGR valve 38, as illustrated in FIG. 1, or may alternatively be positioned between the exhaust gas outlet of the EGR cooler 40 and the EGR valve 38 in embodiments that include the EGR valve 38. In any case, the flow restriction or flow restriction device 42, in the illustrated embodiment, defines a cross-sectional flow area that is less than the smallest cross-sectional flow area of the EGR valve 38 so that the flow restriction or flow restriction device 42 defines the dominant flow restriction in the EGR conduit 36. In alternate embodiments, the flow restriction or flow restriction device 42 may be omitted, and the flow restriction defined by the EGR valve 38 may define the only flow restriction in the EGR conduit 36.

The system 10 further includes a control circuit 44 that is generally operable to control and manage the overall operation of the engine 12. The control circuit 44 includes a memory unit 46 as well as a number of inputs and outputs for interfacing with various sensors and systems coupled to the engine 12. The control circuit 44 is illustratively includes a conventional microprocessor, although this disclosure contemplates other embodiments in which the control circuit 44 may alternatively be or include a general purpose or application specific control circuit capable of operation as will be described hereinafter. In any case, the control circuit 44 may be a known control unit sometimes referred to as an electronic or engine control module (ECM), electronic or engine control unit (ECU) or the like. Illustratively, the memory 46 of the control circuit 44 has stored therein one or more sets of instructions that are executable by the control circuit 44, as will be described in greater detail hereinafter, to determine one or more engine cylinder operating conditions.

The control circuit 44 includes a number of inputs that receive signals from various sensors or sensing systems associated with system 10. The control circuit 44 is generally operable in a conventional manner to sample the signals produced by the various sensors and/or sensing systems and to process the sampled signals to determine the associated operating conditions. For example, the system 10 includes a temperature sensor 48 that is disposed in fluid communication with the intake manifold 14 and that is electrically connected to an intake manifold temperature input, IMT, of the control circuit 44 via a signal path 50. The temperature sensor 48 may be conventional, and is operable to produce a temperature signal on the signal path 50 that is indicative of the temperature within the intake manifold 14, e.g., the temperature of the charge entering the intake manifold 14 where the term “charge” is defined as the combination of fresh air supplied by the compressor 16 and recirculated exhaust gas supplied by the EGR conduit 36.

The system 10 further includes a speed and position sensor 52 that is electrically connected to an engine speed and position input, ESP, of the control circuit 44 via a signal path 54. The speed and position sensor 52 may be conventional and configured to produce a signal from which the rotational speed of the engine 12 can be determined and from which the rotational position, i.e., the crank angle, of the engine 12 relative to a reference position or reference crank angle can be determined. In this embodiment, the memory 46 includes conventional instructions that are executable by the control circuit 44 to process the signal produced by the sensor 52 to determine the rotational speed of the engine, e.g., in rotations per minute (RPM), and engine position relative to a reference position, e.g., crank angle degrees relative to a reference crank angle such as zero degrees, top-dead-center, or the like. In one embodiment, the speed and position sensor 52 is provided in the form of a conventional Hall effect sensor, although other conventional sensors may alternatively be used. In other embodiments, the speed and position sensor 52 may be replaced by two separate sensors, i.e., a conventional speed sensor configured to produce a signal indicative of rotational speed of the engine 12 and a conventional position or crank angle sensor configured to produce a signal indicative of engine position relative to a reference position, e.g., crank angle relative to a reference crank angle.

The system 10 further includes a pressure sensor 56 that is disposed in fluid communication with the intake manifold 14 and that is electrically connected to an intake manifold pressure input, IMP, of the control circuit 44 via a signal path 58. The pressure sensor 56 may be conventional, and is operable to produce a pressure signal on the signal path 58 that is indicative of the pressure within the intake manifold 14, e.g., the pressure of the charge entering the intake manifold 14.

The system 10 further includes a differential pressure (ΔP) sensor 60 having one fluid input that is illustratively disposed in fluid communication with the EGR conduit 36 adjacent to the exhaust gas outlet of the flow restriction or flow restriction device 42, and another fluid input that is illustratively disposed in fluid communication with the EGR conduit 36 adjacent to the exhaust gas inlet of the flow restriction or flow restriction device 42. The ΔP sensor 60 is electrically connected to a differential pressure input, ΔP, of the control circuit 44 via a signal path 62. In the illustrated embodiment, the differential pressure sensor 60 may be conventional, and is operable to produce a pressure signal on the signal path 62 that is indicative of the pressure differential across the flow restriction or flow restriction device 42. In other embodiments, e.g., embodiments that do not include the flow restriction or flow restriction device 42, the ΔP sensor 60 may be alternatively positioned across the EGR valve 38 such that the pressure signal produced by the sensor 60 is indicative of the pressure differential across the EGR valve 38.

The system 10 further includes another temperature sensor 64 that is disposed in fluid communication with the EGR conduit 36 adjacent to the exhaust gas outlet of the EGR cooler 40, and that is electrically connected to a cooler outlet temperature input, COT, of the control circuit 44 via a signal path 66. The temperature sensor 64 may be conventional, and is operable to produce a temperature signal on the signal path 66 that is indicative of the temperature of the exhaust gas exiting the EGR cooler 40.

The system 10 further includes a flow sensor 68 that is disposed in fluid communication with the air intake conduit 20 between the fresh air outlet of the turbocharger compressor 16 and the junction of the EGR conduit 36 and the air intake conduit 20. The flow sensor 68 is electrically connected to a fresh air flow rate input, FAFR, of the control circuit 44 via a signal path 70. The flow sensor 68 may be a conventional mass air flow sensor or other conventional flow sensor, and is operable to produce a signal on the signal path 70 that is indicative of the flow rate of fresh air supplied by the turbocharger compressor 16 to the intake manifold 14 of the engine 12.

The system 10 further includes another pressure sensor 72 that is disposed in fluid communication with the exhaust conduit 32 between the exhaust gas outlet of the turbocharger turbine 24 and the at least one exhaust flow restriction device 34. The pressure sensor is electrically connected to a turbine outlet pressure input, TOP, of the control circuit 44 via a signal path 74. The pressure sensor 72 may be conventional, and is operable to produce a pressure signal on the signal path 74 that is indicative of the pressure the exhaust gas exiting the turbocharger turbine 24. In embodiments of the system 10 that do not include the at least one exhaust flow restriction device 34, the pressure sensor 32 produces a pressure signal on the signal path 74 that is indicative of ambient air pressure. In such embodiments, the pressure sensor 72 need not be fluidly coupled to the exhaust conduit 32 and may instead be positioned at any convenient location that is suitable for sensing ambient air pressure.

In some embodiments, the system 10 may further include, as illustrated by dashed-line representation in FIG. 1, a flow sensor 76 that is disposed in fluid communication with the EGR conduit 36, e.g., adjacent to the exhaust gas outlet of the EGR cooler 440 or other suitable location along the EGR conduit 36, and that is electrically connected to an EGR flow rate input, EGRFR, of the control circuit 44 via a signal path 78. In embodiments that include the flow sensor 76, the sensor 76 may be conventional, e.g., provided in the form of a mass flow rate sensor or other conventional flow sensor, and is operable to produce a flow signal on the signal path 78 that is indicative of the flow rate of exhaust gas flowing through the EGR conduit 38.

The system 10 is illustrated in FIG. 1 and described as including physical sensors producing electrical signals that are indicative of intake manifold temperature and pressure, engine speed and position, EGR cooler outlet temperature, EGR flow restriction pressure differential, intake air flow rate, turbine outlet pressure and, in some embodiments, EGR flow rate. It will be understood, however, that one or more of these parameters may be alternatively or additionally estimated by the control circuit 44 as a function of electrical signals produced by one or more other physical sensors, i.e., sensors other than those positioned and configured to produce signals that correspond to a direct measure of the subject parameter(s).

The system 10 further includes a conventional fuel system 80 that is operatively coupled to the engine 12 and that is electrically coupled to a fuel command output, FC, of the control circuit 44 via a number, M, of signal paths 82 where M may be any positive integer. The fuel system 80 is responsive to the number of fuel commands produced by the control circuit 44 to supply corresponding fuel amounts to the various cylinders of the engine 12 in a conventional manner.

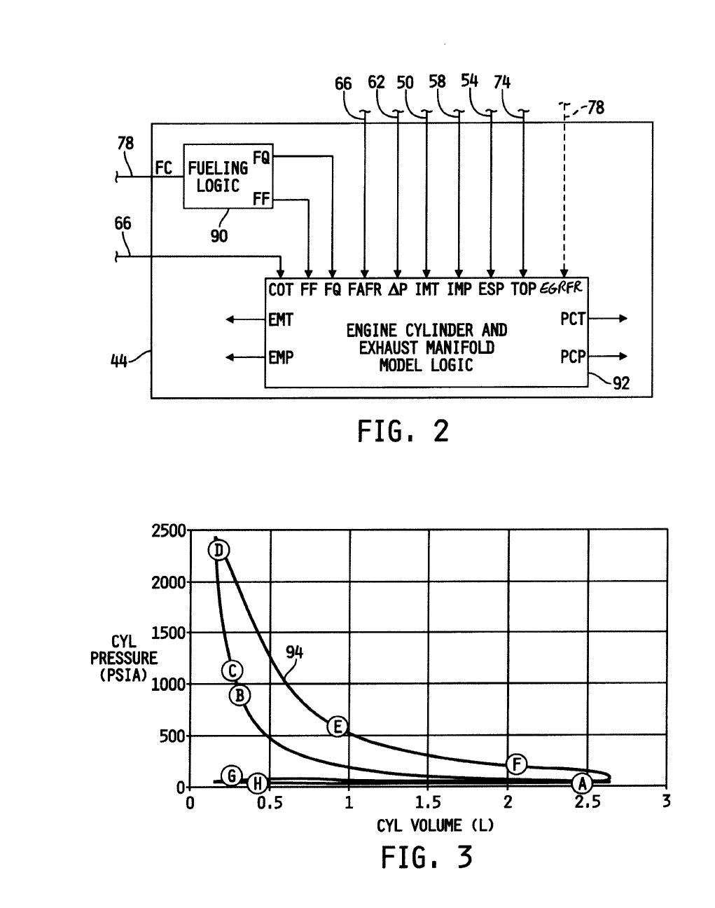

Referring now to FIG. 2, a block diagram is shown of one illustrative embodiment of the control circuit 44 of FIG. 1 configured to determine engine cylinder operating conditions. It will be understood that the various functional blocks illustrated in FIG. 2, as well as functional blocks and/or flowcharts illustrated in the remaining figures, represent individual instructions or instruction sets stored in the memory 46 and executable by the control circuit 44 to carry out the corresponding functions as will be described in greater detail hereinafter. Together, such functional blocks and/or flowcharts represent one illustrative embodiment of instructions that are stored in the memory unit 46 and are executable by the control circuit 44 to determine engine cylinder operating conditions and to also determine exhaust manifold operating conditions.

In the illustrated embodiment, the control circuit 44 includes a conventional fueling logic block 90 that receives input information corresponding to various engine operating conditions and produces fueling commands, FC, for controlling operation of the fueling system 80 in a conventional manner. In the process of determining the fueling commands for the various cylinders of the engine 12, two parameters are conventionally determined which are illustratively used by an engine cylinder and exhaust manifold model logic block 92. These two parameters include a fueling quantity, FQ, corresponding to a quantity or amount of fuel to be supplied to the cylinders of the engine 12 during the current engine cycle and a fuel flow rate value, FF, corresponding to a flow rate of fuel to be supplied to the cylinders of the engine 12 during the current engine cycle. Typically, FQ and FF are updated by the control circuit 44 every engine cycle which illustratively corresponds to two full revolutions of the engine crank shaft.

In addition to FQ and FF, the engine cylinder and exhaust manifold model logic block 92 receives as inputs the EGR cooler outlet temperature signal, COT, on the signal path 66, the fresh air flow rate signal, FAFR, on the signal path 70, the pressure differential signal, ΔP, on the signal path 62, the intake manifold pressure signal, IMP, on the signal path 58, the engine speed and position signal, ESP, on the signal path 54, the turbine outlet pressure signal, TOP, on the signal path 74 and, in some embodiments, the EGR flow rate signal, EGRFR, on the signal path 78. As it will be described in greater detail hereinafter, the engine cylinder and exhaust manifold model logic block 92 is configured to process the various input signals and information and determine cylinder and exhaust manifold operating conditions during each engine cycle for one particular cylinder of the engine 12. It will be understood that the control circuit 44 will typically include a plurality of the engine cylinder and exhaust manifold model logic blocks 92; one for each cylinder of the engine 12 so that the engine cylinder operating conditions for each of the cylinders of the engine and the exhaust manifold operating conditions resulting from such cylinder operation may be monitored. Via any of the plurality of engine cylinder and exhaust manifold model logic blocks 92, the control circuit 44 is illustratively configured to determine a corresponding peak cylinder temperature, PCT, and peak cylinder pressure, PCP, per engine cycle, and to also determine an exhaust manifold temperature, EMT, and an exhaust manifold pressure, EMP, resulting from the cylinder operating conditions for each engine cycle. It will be understood that in some embodiments, more or less information may be determined by the control circuit 44 using any of the plurality of engine cylinder and exhaust manifold model logic blocks 92. For example, this disclosure contemplates embodiments in which one or more of the plurality of engine cylinder and exhaust manifold model logic blocks 92 may be configured to produce any single one or combination of peak cylinder temperature, peak cylinder pressure, exhaust manifold temperature and exhaust manifold pressure. In any case, the peak cylinder temperature, PCT, peak cylinder pressure, PCP, exhaust manifold temperature, EMT, and/or exhaust manifold pressure, EMP, values are stored in the memory 46 and/or are used by one or more other algorithms executed by the control circuit 44.

Referring now to FIG. 3, a plot 94 is shown of cylinder pressure (PSIA) vs. cylinder clearance volume (Liters) for one cylinder of an example four-stroke, direct-injected, turbocharged and after-cooled EGR diesel engine 12. It will be understood that the plot 94 is provided only by way of example, and that the concepts illustrated and described herein should not be limited to the operation of the cylinder in the example engine of FIG. 3 but are rather applicable to other engines and engine types. In the illustrated plot, various capitol letters are overlaid on the plot 94 to identify some of the cylinder-related events that occur during a complete engine cycle. For example, point A on the plot 94 marks the point at which the intake valve (not shown) is closed. At this point all of the charge for the current engine cycle, which is made up of fresh air supplied by the turbocharger compressor 16 and may also include exhaust gas supplied by the EGR conduit 36, is trapped in the cylinder. As the piston thereafter moves upwardly in the cylinder during the compression phase of the engine cycle, cylinder pressure increases and cylinder volume decreases. Point B on the plot 94 marks the start of injection and corresponds to the point at which fuel injection into the cylinder begins. Shortly thereafter at point C on the plot 94, combustion of the air-fuel mixture in the cylinder begins as a result of a further increase in cylinder pressure and reduction in cylinder volume as fuel is injected into the cylinder. Combustion occurs between points C and D on the plot 94 as the piston continues to move upwardly, thereby continuing to increase the cylinder pressure and decrease the cylinder volume. The point D marks the end of fuel injection as the combustion process continues and drives the cylinder downwardly such that the cylinder pressure begins to decrease and the cylinder volume begins to increase.

Combustion continues between points D and E on the plot 94 as the cylinder pressure decreases and the cylinder volume increases, and the point E marks the end of combustion. The piston continues to move downwardly, thereby decreasing cylinder pressure and increasing cylinder volume, and at point F on the plot 94 the exhaust valve (not shown) is opened. Shortly thereafter, the piston begins to move upwardly, thereby pushing the exhaust gas out of the cylinder via the open exhaust valve as the cylinder volume decreases to the point G on the plot 94. At the point G, the intake valve is opened, and shortly thereafter the piston begins to move downwardly, thereby drawing new charge into the cylinder as the cylinder volume increases. At the point H, the exhaust valve is closed, and between the points H and A the charge for the next engine cycle is drawn into the cylinder. The process then continues from point A, as described above, for each subsequent engine cycle.

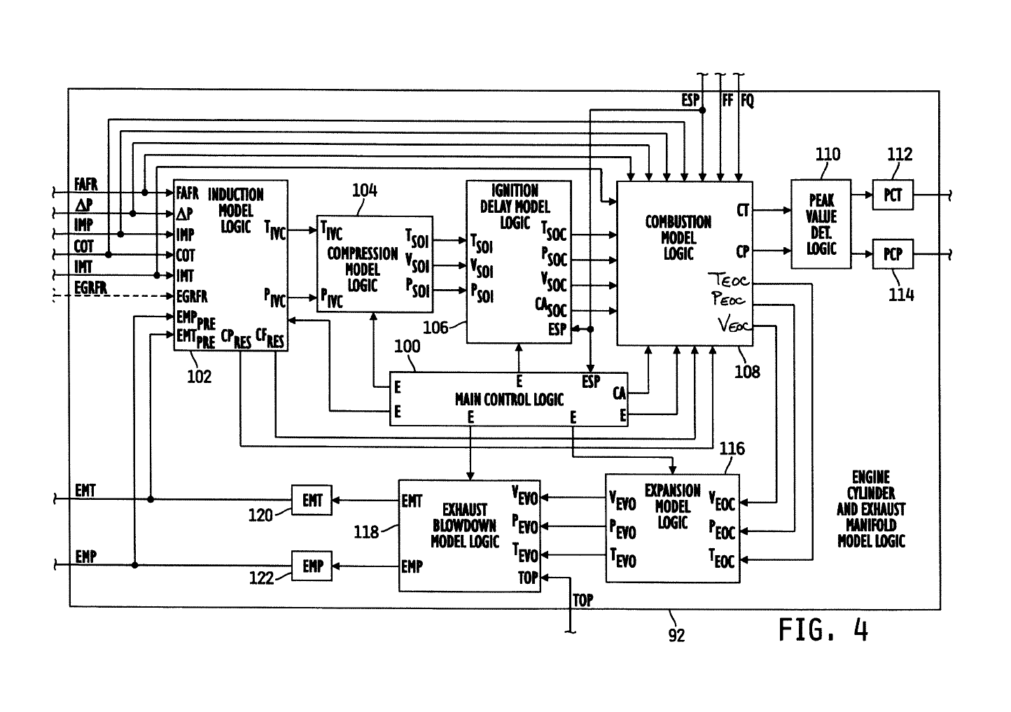

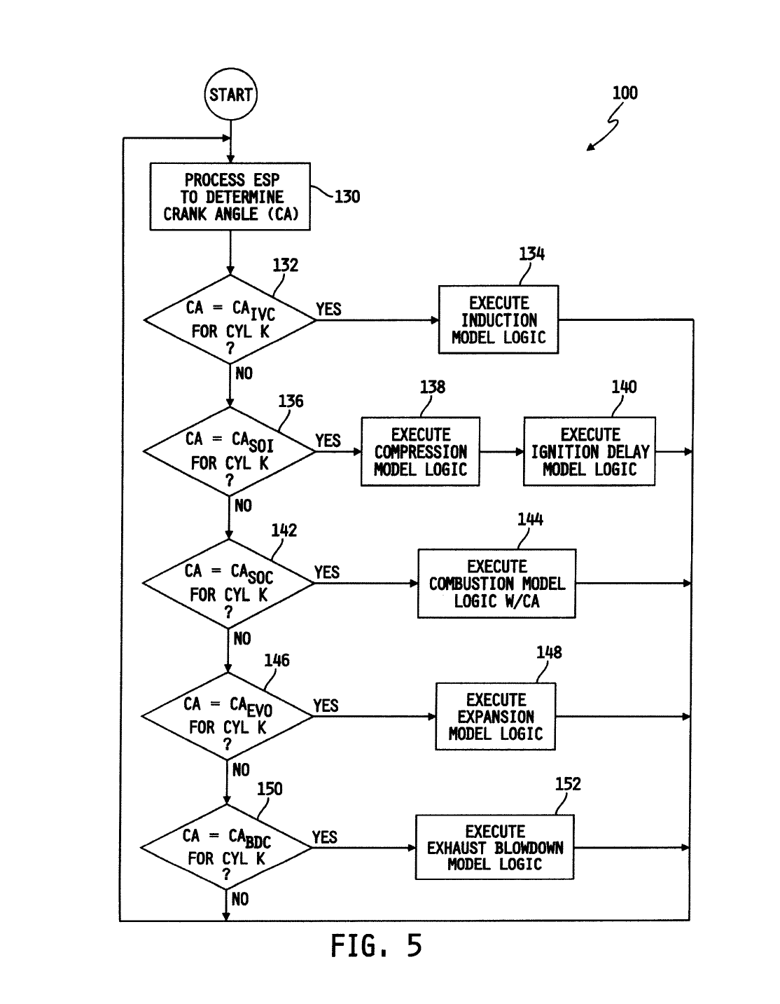

Referring now to FIG. 4, one illustrative embodiment of the engine cylinder and exhaust manifold model logic block 92 of FIG. 2. In the illustrated embodiment, the model logic block 92 includes a number of different model logic blocks which are sequentially executed once during each engine cycle. A main control logic block 100 receives as an input the engine speed and position signal, ESP, and includes a number of enable outputs, E, that are each connected to a different one of the number of different model logic blocks. The block 92 further includes an induction model logic block 102 that receives as inputs the fresh air flow rate, FAFR, the EGR flow restriction pressure differential, ΔP, the intake manifold pressure, IMP, the EGR cooler outlet temperature, COT, the intake manifold temperature, IMT, an estimated exhaust manifold pressure value from the previous engine cycle, EMP_{PRE}, an estimated exhaust manifold temperature value from the previous engine cycle, EMT_{PRE}. In some embodiments, the induction model logic block 102 may be configured to receive a recirculated exhaust gas flow rate signal, EGRFR, produced by an EGR flow rate sensor 76 (see FIG. 1) and as shown by dashed-line representation in FIG. 4, in place of the ΔP and COT values. In any case, the induction model logic block 102 is operable, as will be described in detail hereinafter with reference to one illustrative embodiment thereof, to process the foregoing input information to determine and produce cylinder temperature and pressures, T_{IVC} and P_{IVC} respectively, at the point in the engine cycle at which the intake valve is closed (IVC), e.g., at the point A in the plot 94 of FIG. 3. The induction model logic block 102 is further illustratively operable to determine and produce an intake charge specific heat capacity at constant pressure, CP_{IN}, and a residual mass flow rate, CF_{RES}.

The model block 92 further includes a compression model logic block 104 that receives as inputs the cylinder temperature and pressure values at intake valve closing, T_{IVC} and P_{IVC} respectively, produced by the induction model logic block 102. The compression model logic block 104 processes this input information to determine a cylinder temperature, T_{SOI}, a cylinder pressure, P_{SOI} and a cylinder clearance volume, V_{SOI} respectively, at the point in the engine cycle at which the start of fuel injection occurs (SOI), e.g., at the point B in the plot 94 of FIG. 3.

The model block 92 further includes an ignition delay model logic block 106 that receives as inputs the cylinder temperature at the start of fuel injection, T_{SOI}, the cylinder pressure at the start of fuel injection, P_{SOI}, and the cylinder clearance volume at the start of fuel injection, V_{SOI}, from the compression model logic block 104, and also receives the engine speed and position signal, ESP. The ignition delay model logic block 106 processes this input information to determine a cylinder temperature, T_{SOC}, a cylinder pressure, P_{SOC}, a cylinder clearance volume, V_{SOC}, and an engine position, e.g., a crank angle, CA_{SOC}, at the point in the engine cycle at which the start of combustion occurs (SOC), e.g., at the point C in the plot 94 of FIG. 3.

The model block 92 further includes a compression model logic block 108 that receives as inputs the cylinder temperature at the start of combustion, T_{SOC}, the cylinder pressure at the start of combustion, P_{SOC}, the cylinder clearance volume at the start of combustion, V_{SOC}, and the engine position, e.g., crank angle, CA_{SOC}, at the start of combustion, from the ignition delay model logic block 106. The combustion model logic block 108 further receives as inputs the fresh air flow rate, FAFR, the EGR flow restriction pressure differential, ΔP, the intake manifold pressure, IMP, the EGR cooler outlet temperature, COT, the engine speed and position signal, ESP, as well as the fuel flow and fuel quantity values, FF and FQ respectively, produced by the fueling logic block 90 of FIG. 2. Although not specifically illustrated in FIG. 4, in embodiments that include an EFR flow sensor 76 as illustrated by dashed-line representation in FIG. 1, the combustion model logic block 108 may receive the EGR flow rate, EGRFR, in place of FAFR, ΔP and COT. In any case, the combustion model logic block 108 illustratively processes this input information to determine a cylinder temperature, CT, and a cylinder pressure, CP, at discrete intervals throughout the combustion process.

In the illustrated embodiment, the model block 92 further includes a peak value determination logic block 110 that receives the cylinder temperature and cylinder pressure values, CT and CP respectively, and processes these values to determine a corresponding peak cylinder temperature, PCT, which is stored in a memory location 112, and a peak cylinder pressure, PCP, which is stored in a memory location 114. The peak cylinder temperature, PCT, illustratively corresponds to the peak or highest-valued one of the cylinder temperature values, CT, and the peak cylinder pressure, PCP, illustratively corresponds to the peak or highest-valued one of the cylinder pressure values, CP, respectively produced by the combustion model logic block 108 during the current engine cycle. PCT thus corresponds to the peak cylinder temperature during the current engine cycle, and PCP corresponds to the peak cylinder pressure during the current engine cycle. PCT and/or PCP may alternatively or additionally be provided to one or more other algorithms executed by the control circuit 44 or other control circuit. PCT and/or PCP may illustratively be further processed over a plurality of engine cycles or over a defined time period, using additional but conventional logic, to determine peak values over a defined number of engine cycles or over a defined time period, to determine peak value averages over a defined number of engine cycles or over a defined time period, or the like. In any case, it will be understood that this disclosure contemplates further embodiments in which only one of PCT and PCP is determined and stored in memory and/or provided to one or more other algorithms executed by the control circuit 44 or other control circuit.

In the illustrated embodiment, the combustion model logic block 108 is further or alternatively operable to process the input information to determine a cylinder temperature, T_{EOC}, a cylinder pressure, P_{EOC}, and a cylinder clearance volume, V_{EOC}, at the point in the engine cycle at which the end of combustion occurs (EOC), e.g., at the point E in the plot 94 of FIG. 3.

The model block 92 further includes an expansion model logic block 116 that receives as inputs the cylinder temperature at the end of combustion, T_{EOC}, the cylinder pressure at the end of combustion, P_{EOC}, and the cylinder clearance volume at the end of combustion, V_{EOC}, from the combustion model logic block 108. The expansion model logic block 116 processes this input information to determine a cylinder temperature, T_{EVO}, a cylinder pressure, P_{EVO}, and a cylinder clearance volume, V_{EVO}, at the point in the engine cycle at which the exhaust valve is opened (EVO), e.g., at the point F in the plot 94 of FIG. 3.

The model block 92 further includes an exhaust blowdown model logic block 118 that receives as inputs the cylinder temperature at the opening of the exhaust valve, T_{EVO}, the cylinder pressure at the opening of the exhaust valve, P_{EVO}, and the cylinder clearance volume at the opening of the exhaust valve, V_{EVO}, from the expansion model logic block 116. The exhaust blowdown model logic block 118 illustratively processes this input information to determine an exhaust manifold temperature, EMT, and an exhaust manifold pressure, EMP, which are illustratively stored in memory locations 120 and 122 respectively. Alternatively or additionally, EMT and/or EMP may be provided as an output of the engine cylinder and exhaust manifold logic block 92 for use by one or more other algorithms executed by the control circuit 44 or other control circuit. EMT and EMP are further illustratively provided to the induction model logic block 102 as inputs of the exhaust manifold temperature and pressure respectively from the previous engine cycle, i.e., EMT_{PRE} and EMP_{PRE} respectively. It will be understood that this disclosure further contemplates embodiments in which only EMT or EMP is stored in memory and/or is provided as an output for use by another algorithm. In any case, EMT represents the exhaust manifold temperature resulting from operation of the cylinder during the current engine cycle, and EMP represents the exhaust manifold pressure resulting from operation of the cylinder during the current engine cycle. This disclosure further contemplates that the control circuit 44 may include additional but conventional logic that processes EMT and/or EMP over a number of engine cycles or over a defined time period to determine an average, peak or other exhaust manifold temperature and/or exhaust manifold pressure resulting from operation of the cylinder over a defined number of engine cycles or over a defined time period. Additionally or alternatively, the control circuit 44 may include other additional but conventional logic that processes EMT and/or EMP for every cylinder, i.e., produced by engine cylinder and exhaust manifold logic blocks 92 for each of the cylinders of the engine 12, to determine an overall or average exhaust manifold temperature and/or pressure during the current engine cycle, over a defined number of engine cycles and/or over a defined time period.

In embodiments of the engine cylinder and exhaust manifold model logic block 92 in which the combustion model logic block is not configured to produce T_{EOC}, P_{EOC} and V_{EOC}, the logic blocks 116 and 118 may be omitted, although EMT_{PRE} and EMP_{PRE} will have to be supplied by another exhaust manifold temperature and pressure estimation algorithm or via suitable sensors positioned and configured to produce temperature and pressure signals indicative of exhaust manifold temperature and pressure respectively. In this alternative embodiment, the engine model logic block 92 is to determine and produce only PCT and/or PCP, but not EMT or EMP. In embodiments of the engine cylinder and exhaust manifold model logic block 92 in which the combustion model logic block is configured to produce T_{EOC}, P_{EOC} and V_{EOC}, the combustion model logic block may not be configured to produce CT and CP, and the peak value detection logic block 110, as well as the memory blocks 112 and 114, may be omitted. In this alternative embodiment, the model logic block 92 is configured to determine and produce only EMT and/or EMP, but not PCT or PCP.

The main control logic block 100 is generally operable to process the engine speed and position signal, ESP, and to then selectively and sequentially enable each of the remaining model logic blocks of the engine cylinder and exhaust manifold model logic block 92 depending upon the current position, e.g., crank angle, of the engine 12. Referring now to FIG. 5, a flowchart is shown of one illustrative example of a process that makes up the main control logic block 100. The process 100 illustrated in FIG. 5 is executable with respect to the Kth cylinder of an L-cylinder engine, where L may be any positive integer and where 1≦K≦L. Typically, as described briefly hereinabove, the control circuit 44 will include a number of engine cylinder and exhaust manifold model logic blocks 92 equal to the total number of cylinders, so that each of the number of engine cylinder and exhaust manifold logic blocks 92 processes information relating to a different one of the cylinders. In this sense, the engine cylinder and exhaust manifold logic block 92 illustrated in FIGS. 4-12, is illustratively configured to process information relating to the Kth one of the L cylinders of the engine 12.

Generally, the various cylinder-related events that take place during one complete engine cycle, such as those illustrated in FIG. 3, occur at different, successive crank angles for any one cylinder of the engine 12. The main control logic block 100 of FIG. 5 illustratively controls the timing of execution of each of the remaining model logic blocks in the engine cylinder and exhaust manifold model logic block 92 so that each of the various models are sequentially executed as the actual engine crank angle advances to a corresponding crank angle specified for each logic block.

The process 100 begins at step 130 where the control circuit 44 processes the engine speed and position signal, ESP, to determine the current position of the engine, e.g., the current crank angle, CA. As described briefly above, the current crank angle corresponds to a current angle of the engine crank shaft (not shown) relative to a reference crank angle. In one illustrative embodiment, the reference crank angle corresponds to the position of the engine crank shaft when the piston of one of the cylinders, e.g., a first cylinder in the firing or combustion order of all of the cylinders of the engine, is at a top-dead-center (TDC) position. Thus, for example, if cylinder number one of a four cylinder engine is the first cylinder in the combustion order of all of the cylinders of the engine 12, the reference crank angle would be the TDC position of cylinder number 1. It will be understood, however, that the reference crank angle may alternatively be any desired position of the crank shaft of the engine 12. In any case, the control circuit 44 uses a conventional signal processing technique to determine the current crank angle, CA, and the process 100 advances from step 130 to step 132.

At step 132, the control circuit 44 determines whether the current crank angle, CA, is equal to the intake valve closed crank angle, CA_{IVC}, (e.g., point A of the plot 94 of FIG. 3) for the Kth cylinder. Generally, CA_{IVC} will be known in advance for each cylinder and will typically be different for each of the L cylinders. In any case, if the control circuit 44 determines at step 132 that CA of the Kth cylinder is equal to CA_{IVC}, execution of the process 100 advances to step 134 where the induction model logic block 102 is executed by the control circuit 44. Steps 132 and 134 of the main control logic process 100 thus enable execution, e.g., operation, of the induction model logic block for the Kth cylinder of the engine 12 when the crank angle, CA, is equal to the crank angle, CA_{IVC}, at which the intake valve for the Kth cylinder of the engine 12 is closed. Following execution of step 134, the process 100 loops back to step 130.

If, at step 132, the control circuit 44 determines that CA is not equal to CA_{IVC} for the Kth cylinder, execution of the process 100 advances to step 136 where the control circuit 44 determines whether the current crank angle, CA, is equal to the start of injection crank angle, CA_{SOI}, (e.g., point B of the plot 94 of FIG. 3) for the Kth cylinder. Generally, CA_{SOI} will be known in advance for each cylinder and will typically be different for each of the L cylinders. If the control circuit 44 determines at step 136 that CA of the Kth cylinder is equal to CA_{SOI}, execution of the process 100 advances to step 138 where the compression model logic block 104 is executed by the control circuit 44. Thereafter at step 140, the control circuit 44 executes the ignition delay model logic block 106. Steps 136, 138 and 140 of the main control logic process 100 thus sequentially enable execution, e.g., operation, of the compression model and ignition delay logic blocks 104 and 106 respectively for the Kth cylinder of the engine 12 when the crank angle, CA, is equal to the crank angle, CA_{SOI}, at which start of fuel injection occurs. Following execution of step 140, the process 100 loops back to step 130.

If, at step 136, the control circuit 44 determines that CA is not equal to CA_{SOI} for the Kth cylinder, execution of the process 100 advances to step 142 where the control circuit 44 determines whether the current crank angle, CA, is equal to the start of combustion crank angle, CA_{SOC}, (e.g., point C of the plot 94 of FIG. 3) for the Kth cylinder. Illustratively, CA_{SOC} for the Kth cylinder is determined by the ignition delay model logic block 106, e.g., as a function of, among other variables, CA_{SOI} as will be described in greater detail hereinafter with respect to FIG. 8. If the control circuit 44 determines at step 142 that CA of the Kth cylinder is equal to CA_{SOC}, execution of the process 100 advances to step 144 where the combustion model logic block 108 is executed by the control circuit 44. Following execution of step 144, the process 100 loops back to step 130.

If, at step 142, the control circuit 44 determines that CA is not equal to CA_{SOC} for the Kth cylinder, execution of the process 100 advances to step 146 where the control circuit 44 determines whether the current crank angle, CA, is equal to the exhaust valve opening crank angle, CA_{EVO}, (e.g., point F of the plot 94 of FIG. 3) for the Kth cylinder. Generally, CA_{EVO} will be known in advance for each cylinder and will typically be different for each of the L cylinders. If the control circuit 44 determines at step 146 that CA of the Kth cylinder is equal to CA_{EVO}, execution of the process 100 advances to step 148 where the expansion model logic block 116 is executed by the control circuit 44. Following execution of step 148, the process 100 loops back to step 130.

If, at step 146, the control circuit 44 determines that CA is not equal to CA_{EVO} for the Kth cylinder, execution of the process 100 advances to step 150 where the control circuit 44 determines whether the current crank angle, CA, is equal to the bottom dead center crank angle, CA_{BDC}, for the Kth cylinder. Generally, CA_{BDC} will be known in advance for each cylinder and will typically be different for each of the L cylinders. If the control circuit 44 determines at step 150 that CA of the Kth cylinder is equal to CA_{BDC}, execution of the process 100 advances to step 152 where the exhaust blowdown model logic block 118 is executed by the control circuit 44. Following execution of step 152 and the “NO” branch of step 150, the process 100 loops back to step 130.

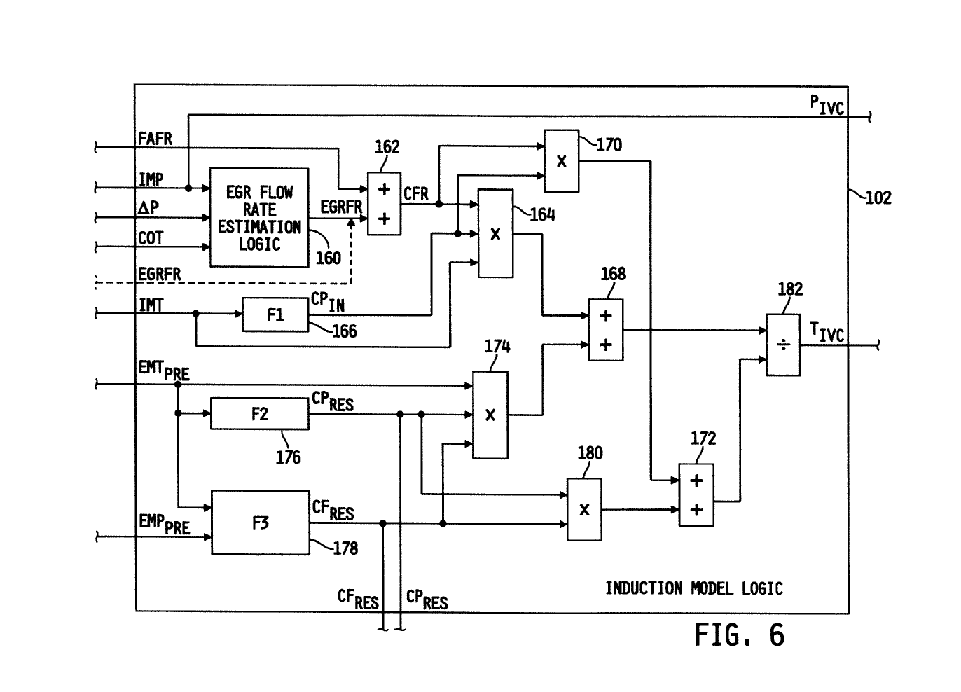

Referring now to FIG. 6, one illustrative embodiment of the induction model logic block 102 illustrated in FIG. 4 is shown. In the illustrated embodiment, an EGR flow rate estimation logic block 160 receives as inputs the intake manifold pressure signal, IMP, on the signal path 58, the pressure differential signal, ΔP, on the signal path 86, and the EGR cooler outlet temperature signal, COT, on the signal path 66. The control circuit 44 processes IMP, ΔP and COT using an EGR flow rate estimation model stored in the EGR flow rate estimation logic block 160 to produce an estimated, instantaneous EGR flow rate value, EGRFR. In one illustrative embodiment, the EGR flow rate model is given by the equation:

$$EGRFR = \frac{{C}_{D} \cdot {A}_{T} \cdot ( IMP - Δ P )}{\sqrt{R \cdot COT}} \cdot {( Δ P )}^{\frac{1}{γ}} \cdot {[ \frac{2 γ}{γ - 1} \cdot {( 1 - Δ P )}^{γ - 1} ]}^{1 / 2} , \qquad ( 1 )$$

where C_{D} is the discharge coefficient and is a stored constant, e.g., 0.67, A_{T} is the cross-sectional flow area of the flow restriction or flow restriction device 42 which is a stored constant based on the physical dimensions of the flow restriction or flow restriction device 42, γ is the ratio of specific heat capacity at constant pressure to specific heat capacity at constant volume for the cylinder charge which is a stored constant, e.g., 1.35, and R is a conventional gas constant, e.g., R=287 J/kgK. It will be understood, however, that this disclosure contemplates other embodiments in which the EGR flow rate estimation model includes more, fewer and/or different input parameters. Alternatively, in systems that include the flow rate sensor 76, the control circuit 44 may be configured to process the flow signal produced by the flow rate sensor 76 in a conventional manner to determine a corresponding EGR flow rate value, and to use the EGR flow rate value determined from the flow signal in place of, or in addition to, the estimated EGR flow rate value produced by the EGR flow rate estimation logic block 160 as indicated by dashed-line representation in FIG. 6. In embodiments in which the EGR flow rate value determined from the flow signal is used in place of the estimated EGR flow rate value produced by the EGR flow rate estimation logic block 160, the EGR flow rate estimation logic block 160 may be omitted from the induction model logic block 102. In any case, the EGR flow rate value, EGRFR, is illustratively provided as one input to an addition block 162 having another input that receives the fresh air flow rate value, FAFR. The output of the addition block 162 is the charge flow rate, CFR, which is the sum of EGRFR and FAFR and corresponds to the flow rate of charge (defined hereinabove) entering the intake manifold of the engine 12.

The output, CFR, of the addition block 162 is supplied to one input of a multiplication block 164 having another input that receives the intake manifold temperature value, IMT, and yet another input receiving the output of a function block 166. The function block 166 receives IMT as an input and has a function, F1, stored therein that processes IMT and produces as an output an intake charge specific heat capacity at constant pressure, CP_{IN}, e.g., F1=CP_{IN}=f(IMT). Illustratively, F1 represents a conventional regression function such that CP_{IN} is a conventional regression fit of IMT. In some alternative embodiments, F1 may be implemented as a table, graph, chart or the like that maps IMT values to CP_{IN} values. In other alternative embodiments, F1 may be implemented as a constant stored in the memory 46. In any case, the output of the multiplication block 164 is the product of CFR, CP_{IN} and IMT, and is provided to one input to another addition block 168. CFR and CP_{IN} are also provided as two separate inputs to another multiplication block 170 having an output that is provided as one input to yet another addition block 172.

The estimated exhaust manifold temperature value from the previous engine cycle, EMT_{PRE}, (produced as an output of the exhaust blowdown model logic block 118 of FIG. 4) is provided as one input of another multiplication block 172. EMT_{PRE} is also provided as an input to two different function blocks 176 and 178. The function block 178 also receives as another input the estimated exhaust manifold pressure value from the previous engine cycle, EMP_{PRE}, (also produced as an output of the exhaust blowdown model logic block 118 of FIG. 4).

The function block 176 has a function, F2, stored therein that processes EMT_{PRE} and produces as an output a residual gas specific heat capacity at constant pressure, CP_{RES}, corresponding to the residual gas specific heat capacity of the charge remaining in the cylinder from the previous engine cycle, e.g., F2=CP_{RES}=f(EMT_{PRE}). Illustratively, F2 represents a conventional regression function such that CP_{RES} is a conventional regression fit of EMT_{PRE}. In some alternative embodiments, F2 may be implemented as a table, graph, chart or the like that maps EMT_{PRE} values to CP_{RES} values. In other alternative embodiments, F2 may be implemented as a constant stored in the memory 46. In any case, CP_{RES} is also produced as an output of the induction model logic block 102.

The function block 178 has a function, F3, stored therein that processes EMT_{PRE} and EMP_{PRE} and produces as an output a residual charge flow rate, CF_{RES}, corresponding to the mass flow rate of charge remaining in the cylinder from the previous engine cycle, e.g., F3=CF_{RES}=f(EMT_{PRE}, EMP_{PRE}). In one illustrative embodiment, F3=CF_{RES} is given by the formula:

$${CF}_{RES} = \frac{{V}_{CL} \cdot {EMP}_{PRE}}{( NCYL \cdot {EMT}_{PRE} \cdot R \cdot 12 )} , \qquad ( 2 )$$

where V_{CL} is the cylinder clearance volume at top-dead-center and is a stored constant, NCYL is the total number of cylinders in the engine 12 and R is the gas constant used in equation (1). It will be understood that with other engines and/or engine configurations, equation (2) may include more, fewer and/or different constants and/or variables. In any case, CF_{RES} is also produced as an output of the induction model logic block 102.

The output of the multiplication block 174 is thus the product of EMT_{PRE}, CP_{RES} and CF_{RES}, and is provided as the other input to the addition block 168. The output of the addition block is provided to a numerator input of a divide block 182. CP_{RES} and CF_{RES} are also supplied as two different inputs to another multiplication block 180, the output of which is provided to another input of the addition block 172. The output of the addition block 172 is provided as the denominator input of the divide block 182. The output of the divide block is the estimated cylinder temperature, T_{IVC}, at CA=CA_{IVC}, and is defined, according to the induction model block 102 illustrated in FIG. 6, by the equation:

$${T}_{IVC} = \frac{CFR \cdot {CP}_{IN} \cdot IMT + {CF}_{RES} \cdot {CP}_{RES} \cdot {EMT}_{PRE}}{CFR \cdot {CP}_{IN} + {CF}_{RES} \cdot {CP}_{RES}} . \qquad ( 3 )$$

At CA=CA_{IVC}, the estimated cylinder pressure, P_{IVC}, is equal to IMP.

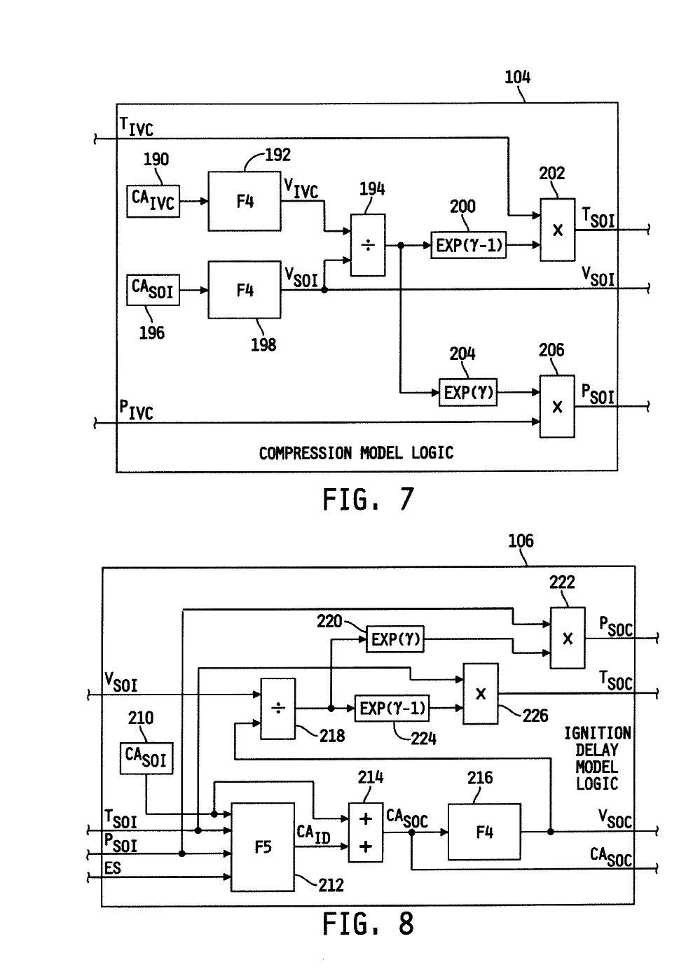

Referring now to FIG. 7, one illustrative embodiment of the compression model logic block 104 illustrated in FIG. 4 is shown. In the illustrated embodiment, the intake valve closing crank angle, CA_{IVC}, for the Kth cylinder is known, and is stored in a memory block 190. CA_{IVC} is provided by the memory block 190 to an input of a function block 192, the output of which is the cylinder volume normalized by the clearance volume, at CA=CA_{IVC}. The function block 192 has a function, F4, stored therein that illustratively defines the cylinder volume normalized by the clearance volume at any engine crank angle. In one illustrative embodiment, this cylinder volume normalized by the clearance volume, V_{CYL}, for any given crank angle, CA, is given by the equation:

$${V}_{CYL} = 1 + \frac{1}{2} ( {r}_{C} - 1 ) [ RR + 1 - cos ( CA ) - \sqrt{{RR}^{2} - {sin}^{2} ( CA )} ] , \qquad ( 4 )$$

where r_{C} is the compression ratio of the engine 12 which is illustratively a constant stored in the memory 46, RR is the ratio of connecting rod length to crank radius which is also illustratively a constant stored in the memory 46, and CA is the input crank angle. In the embodiment of the compression model logic illustrated in FIG. 7, the function block 192 has equation (4) stored therein as the function F4, and with the crank angle at intake valve closing, CA_{IVC}, as the input crank angle, the output of the function block 192 is thus the cylinder volume normalized by the clearance volume, V_{CYL}, at CA=CA_{IVC}, or V_{IVC}. The value V_{IVC} is provided as a numerator input to a divide block 194. As described hereinabove, the compression model logic block 104 is executed at the point in the revolution of the engine crank shaft at which CA=CA_{SOI}, which is generally past the rotational point at which CA=CA_{IVC}, and in this sense blocks 190 and 192 may alternatively reside in the induction model block 102 without any loss of continuity.

In the embodiment illustrated in FIG. 7, the start of injection crank angle, CA_{SOI}, for the Kth cylinder is known, and is illustratively stored in a memory block 196. CA_{SOI} is provided by the memory block 196 to an input of another function block 198, the output of which is the cylinder volume normalized by the clearance volume, at CA=CA_{SOI}. The function block 196 has the function, F4, stored therein that is illustratively provided in the form of equation (4) above. The output of the function block 198 is thus the cylinder volume normalized by the clearance volume, V_{CYL}, at CA=CA_{SOI}, or V_{SOI}. The value V_{SOI} is provided as an output of the compression model logic block 104, and also as a denominator input to the divide block 194, such that the output of the divide block is the ratio of V_{IVC} and V_{SOI}. The output of the divide block 194 is provided as an input to another function block 200 illustratively having the expression exp(γ−1) stored therein. The output of the function block 200 is provided as one input of a multiplication block 202 having another input receiving T_{IVC} produced by the induction model logic block 102. The output of the multiplication block 202 is the estimated cylinder temperature, T_{SOI} at the start of fuel injection, i.e., at CA=CA_{SOI}, and is thus defined, according to the compression model logic block 104 illustrated in FIG. 7, by the equation:

$${T}_{SOI} = {T}_{IVC} \cdot {( \frac{{V}_{IVC}}{{V}_{SOI}} )}^{γ - 1} . \qquad ( 5 )$$

The output of the divide block 194 is also provided as an input to yet another function block 204 illustratively having the expression exp(γ) stored therein. The output of the function block 204 is provided as one input of a multiplication block 206 having another input receiving P_{IVC} produced by the induction model logic block 102. The output of the multiplication block 206 is the estimated cylinder pressure, P_{SOI}, at the start of fuel injection, i.e., at CA=CA_{SOI}, and is thus defined, according to the compression model logic block 104 illustrated in FIG. 7, by the equation:

$${P}_{SOI} = {P}_{IVC} \cdot {( \frac{{V}_{IVC}}{{V}_{SOI}} )}^{γ} . \qquad ( 6 )$$

Referring now to FIG. 8, one illustrative embodiment of the ignition delay model logic block 106 illustrated in FIG. 4 is shown. In the illustrated embodiment, the start of injection crank angle, CA_{SOI}, for the Kth cylinder is illustratively stored in a memory block 210, and is provided as one input to a function block 212. The values T_{SOI} and P_{SOI} produced by the compression model logic block 104 are also provided as inputs to the function block. The control circuit 44 is configured in a conventional manner to process the engine speed and position signal, ESP, to determine the rotational speed, ES, of the engine 12, and the engine rotational speed value, ES, is supplied as yet a further input to the function block 212. The function block 212 has a function F5 stored therein that illustratively computes an ignition delay crank angle, CA_{ID}, as a function of CA_{SOI}, T_{SOI}. P_{SOI} and ES, e.g., F5=CA_{ID}=f(CA_{SOI}, T_{SOI}, P_{SOI}, ES). In one illustrative embodiment, F5=CA_{ID} is given by the formula:

$${CA}_{ID} = A \cdot ES \cdot {P}_{SOI}^{B} \cdot {e}^{\frac{C}{TSOI}} \cdot {e}^{D \cdot {CA}_{SOI}} , \qquad ( 7 )$$

where A, B, C and D are calibration parameters which are illustratively stored in the memory 46 as constants. The ignition delay crank angle, CA_{ID} is provided as one input to an addition block having another input receiving the crank angle at the start of injection, CA_{SOI}, and the output of the addition block is the crank angle at the start of combustion, CA_{SOC}, corresponding to the crank angle at which air/fuel combustion within the Kth cylinder begins following the start of injection and ignition delay. CA_{SOC} is produced as an output of the ignition delay model logic block 106 and is also provided as an input to a function block 216 illustratively having the function F4, e.g., equation 4, stored therein. The output of the function block 216 is the cylinder volume, V_{SOC}, normalized by the clearance volume at CA=CA_{SOC}, and is provided as an output of the ignition delay model logic block 106 and also as the denominator input of a divide block 218.

The cylinder volume, V_{SOI}, produced by the compression model logic block 104 is provided as the numerator input of the divide block 218, and the output of the divide block 218 is provided as an input to a function block 220 and also to a function block 224. The function block 220 illustratively has the expression exp(γ) stored therein, and the output of the function block 220 is provided to one input of a multiplication block 222 having another input receiving P_{SOI} produced by the compression model logic block 104. The output of the multiplication block 222 is produced as an output of the ignition delay model logic block 106 as the estimated cylinder pressure, P_{SOC}, at the start of fuel combustion, i.e., at CA=CA_{SOC}, and is thus defined, according to the ignition delay model logic block 106 illustrated in FIG. 8, by the equation:

$${P}_{SOC} = {P}_{SOI} \cdot {( \frac{{V}_{SOI}}{{V}_{SOC}} )}^{γ} . \qquad ( 8 )$$

The function block 224 illustratively has the expression exp(γ−1) stored therein. The output of the function block 224 is provided to one input of a multiplication block 226 having another input receiving T_{SOI} produced by the compression model logic block 104. The output of the multiplication block 226 is produced as an output of the ignition delay model logic block 106 as the estimated cylinder temperature, T_{SOC}, at the start of combustion, i.e., at CA=CA_{SOC}, and is thus defined, according to the ignition delay model logic block 106 illustrated in FIG. 8, by the equation:

$${T}_{SOC} = {T}_{SOI} \cdot {( \frac{{V}_{SOI}}{{V}_{SOC}} )}^{γ - 1} . \qquad ( 9 )$$

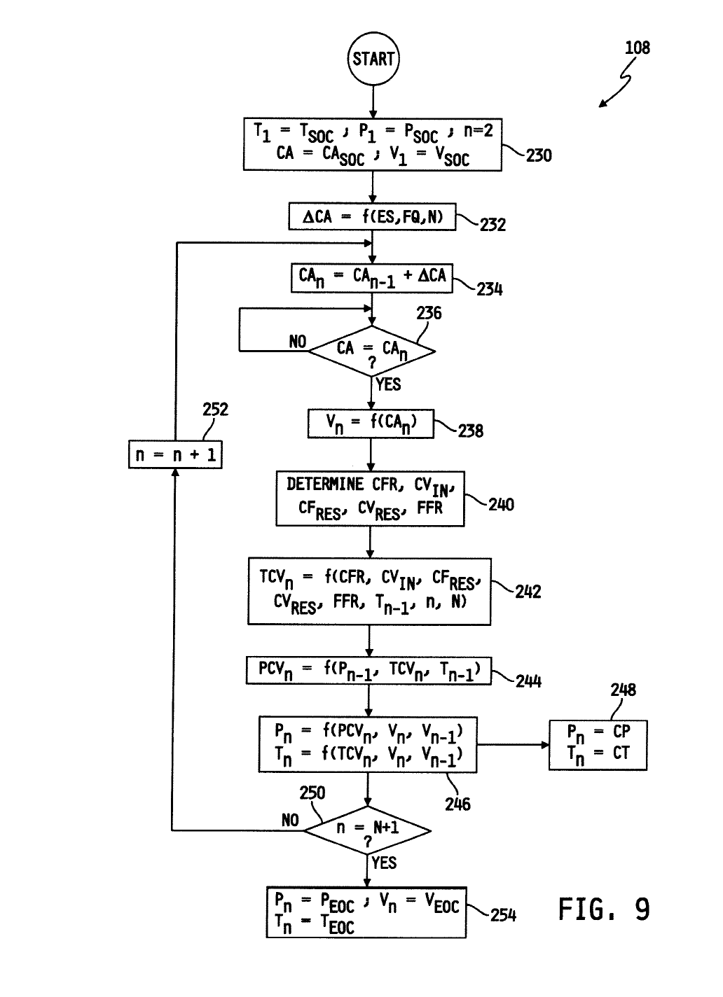

Referring now to FIG. 9, a flowchart is shown of one illustrative embodiment of a process that makes up the combustion model logic block 108 illustrated in FIG. 4. The process 108 illustrated in FIG. 9 is generally configured to model the change in cylinder operating conditions during the combustion process from the start of combustion to the end of combustion. In the illustrated embodiment, the fuel injection profile, i.e., normalized fuel injection rate vs. normalized engine crank angle, is modeled as a Gaussian distribution, and is partitioned into a discrete number, N, of combustion packets, e.g., of width or duration ΔCA that corresponds to the fuel injection duration of each combustion packet, with the combustion process for each of the packets being modeled as a constant-volume heat release process. Each such packet of energy is considered to be released at a particular volume and that acts over that volume to do work. In one illustrative embodiment, N=21 such that 21 discrete combustion packets are defined between the crank angle at the start of combustion, CA_{SOC} (e.g., point C on the plot 94 of FIG. 3), and the crank angle at the end of combustion, CA_{EOC} (e.g., point E on the plot 94 of FIG. 3), although it will be understood that in other embodiments N may be any positive integer.

In the embodiment illustrated in FIG. 9, the process 108 begins at step 230 where the control circuit 44 defines a number of initial variables for the Kth cylinder of the engine 12. Specifically, a first of N cylinder temperature values, T₁, is set to the cylinder temperature at the start of combustion, T_{SOC}, a first of N cylinder pressure values, P₁, is set to the cylinder pressure at the start of combustion, P_{SOC}, a first of N cylinder volume values, V₁, is set to the cylinder volume at the start of combustion, V_{SOC}, a crank angle value, CA, is set to the engine crank angle at the start of combustion, CA_{SOC}, and a counter value, n, is set to 2. Thereafter at step 232, the control circuit 44 is operable to determine the width or duration of each of the N combustion packets, ΔCA, e.g., as a function of the current engine speed, ES, the current fueling quantity, FQ, and the total number of combustion packets, N. In one illustrative embodiment, for example, ΔCA is determined by the control circuit 44 according to the formula:

$$Δ CA = \frac{α \cdot ES \cdot {e}^{β \cdot FQ}}{N} , \qquad ( 10 )$$

where α and β are calibration constants that are illustratively stored in the memory 46.

Following step 232, the control circuit 44 is operable at step 234 to compute crank angle, CAₙ, at the end of the nth combustion packet according to the formula CAₙ=CAₙ₋₁+ΔCA. Thus, for example, the crank angle, CA₂, at the end of the first combustion packet=CA₁+ΔCA=CA_{SOC}+ΔCA, where ΔCA is given by equation (10). Thereafter at step 236, the control circuit 44 is operable to determine whether the current crank angle, CA, is equal to CAₙ, i.e., whether the current crank angle, CA, is equal to the crank angle at the end of the nth combustion packet. If not, the process 108 loops back to the beginning of step 236. If, at step 236, the control circuit 44 determines that CA=CAₙ, the process 108 advances to step 238 where the control circuit 44 determines the cylinder volume, Vₙ, normalized by the clearance volume at CA=CAₙ, i.e., at the end of the nth combustion packet. Illustratively, the control circuit 44 is operable to determine Vₙ using equation (4) above, in which CA=CAₙ. Thereafter at step 240, the control circuit 44 is operable to determine a number of additional operating parameters of the Kth cylinder at the crank angle CAₙ. For example, the control circuit 44 is operable at step 240 to determine the current charge flow rate, CFR, e.g., using any of the techniques illustrated and described hereinabove with respect to FIG. 6. Additionally, the control circuit 44 is operable at step 240 to determine the intake charge specific heat capacity at constant volume, CV_{IN}, the residual gas specific heat capacity at constant volume, CV_{RES}, the residual charge flow rate, CF_{RES}, and the fuel flow rate, FFR. Illustratively, the control circuit 44 is operable to determine CV_{IN} as a function of the current intake manifold temperature, IMT, by first computing CP_{IN} as a function of IMT, e.g., by using the function F1 illustrated and described hereinabove with respect to FIG. 6, and then computing CV_{IN} according to the equation CV_{IN}=CP_{IN}−R, where R is the gas constant used in equations (1) and (2). Further illustratively, the control circuit 44 is operable to determine CV_{RES} as a function of CP_{RES} produced by the induction model logic block 102 of FIG. 6, e.g., according to the equation CV_{RES}=CP_{RES}−R, where R is the gas constant used in equations (1) and (2). Further illustratively, the control circuit 44 is operable to determine CF_{RES} by receiving CF_{RES} from the induction model logic block 102 of FIG. 6, and to determine the fuel flow rate, FFR, by receiving FFR from the fueling logic block 90 of FIG. 2.

Following step 240, the process 108 advances to step 242 where the control circuit 44 is operable to determine the charge temperature, TCVₙ, of the Kth cylinder at the end of the constant-volume heat release of the nth combustion packet as a function of CFR, CV_{IN}, CF_{RES}, CV_{RES}, FFR, Tₙ₋₁, n and N. In one illustrative embodiment, for example, the control circuit 44 is operable to determine TCVₙ according to the formula:

$${TCV}_{n} = \frac{CFR \cdot {CV}_{IN} + {CF}_{RES} \cdot {CV}_{RES}}{( CFR \cdot {CV}_{IN} + {CF}_{RES} \cdot {CV}_{RES} + \frac{n - 1}{N} \cdot FFR \cdot {CV}_{F} )} \cdot {T}_{n - 1} + \frac{\frac{FFR \cdot LHV}{N}}{( CFR \cdot {CV}_{IN} + {CF}_{RES} \cdot {CV}_{RES} + \frac{n - 1}{N} \cdot FFR \cdot {CV}_{F} )} , \qquad ( 11 )$$

where CV_{F} is the fuel specific heat capacity at constant volume, which is illustratively a constant stored in the memory 46, LHV is the lower heat value of the fuel, which is also illustratively a constant stored in the memory 46, and Tₙ₋₁ is the charge temperature at the end of the previous, (n−1)th, combustion packet.

Following step 242, the process 108 advances to step 244 where the control circuit 44 is operable to determine the charge pressure, PCVₙ, of the Kth cylinder at the end of the constant-volume heat release of the nth combustion packet as a function of Pₙ₋₁, TCVₙ, and Tₙ₋₁. In one illustrative embodiment, for example, the control circuit 44 is operable to determine PCVₙ according to the formula:

$${PCV}_{n} = {P}_{n - 1} \cdot ( \frac{{TCV}_{n}}{{T}_{n - 1 }} ) . \qquad ( 12 )$$

Following step 244, the process 108 advances to step 246 where the control circuit 44 is operable to compute the cylinder charge pressure, Pₙ, at the end of the nth combustion packet, and the cylinder charge temperature, Tₙ, at the end of the nth combustion packet. Illustratively, the control circuit 44 is operable to compute Pₙ as a function of PCVₙ, Vₙ and Vₙ₋₁, and in one illustrative embodiment the control circuit 44 is operable at step 246 to compute Pₙ according to the equation:

$${P}_{n} = {PCV}_{n} \cdot {( \frac{{V}_{n - 1}}{{V}_{n}} )}^{γ} . \qquad ( 13 )$$

The control circuit 44 is likewise illustrative operable to compute Tₙ as a function of TCVₙ, Vₙ and Vₙ₋₁, and in one illustrative embodiment the control circuit 44 is operable at step 246 to compute Tₙ according to the equation:

$${T}_{n} = {TCV}_{n} \cdot {( \frac{{V}_{n - 1}}{{V}_{n}} )}^{γ - 1} . \qquad ( 14 )$$

Following step 246, the process 108 advances to step 250. In embodiments that include the peak value determination logic block 112, the process 108 further includes a step 248, and the process 108 also advances from step 246 to step 248 at which the control circuit 44 is operable to set a cylinder pressure variable, CP, equal to the cylinder charge pressure, Pₙ, at the end of the nth combustion packet, and to set a cylinder temperature variable, CT, equal to the cylinder charge temperature, Tₙ at the end of the nth combustion packet.

At step 250, the control circuit 44 is operable to determine whether the current value of n is equal to N+1. If not, the process 108 advances to step 252 where the control circuit 44 is operable to increment the value n by one, and the process 108 loops from step 252 back to step 234 to process another combustion packet. If, on the other hand, the control circuit 44 determines at step 250 that n=N+1, this means that the control circuit 44 has processed all N of the combustion packets and the combustion process is complete, e.g., point E on the plot 94 of FIG. 3 has been reached such that the current crank angle, CA, is equal to the crank angle at the end of combustion, e.g., CA=CA_{EOC}. In embodiments that include the expansion model logic block 116 and the exhaust blowdown model logic block 118, the process 108 advances from the “YES” branch of step 250 to step 254 where the control circuit 44 is operable to set the last, i.e., most recent, cylinder charge pressure value, Pₙ, equal to an end of combustion cylinder pressure variable, P_{EOC}, to set the last, i.e., most recent, cylinder charge temperature value, Tₙ, equal to an end of combustion cylinder charge temperature variable, T_{EOC}, and to set the last, i.e., most recent, cylinder volume value, Vₙ, equal to an end of combustion cylinder volume value, V_{EOC}.

In embodiments that include the peak value determination logic block 110 and the memory blocks 112 and 114, the peak value determination logic block 110 operates in a conventional manner to sequentially process each of the N CT and CP values produced by the combustion model logic block to determine peak values of CT and CP, and to store these peak values as a peak cylinder temperature value, PCT, and a peak cylinder pressure value, PCP, respectively in the memory locations 112 and 114 respectively. In one illustrative embodiment, for example, the peak value determination logic block 110 is operable to store the first CT and CP values produced by the combustion model logic block 108 during each engine cycle in the memory locations 112 and 114 respectively, and to then process each additional set of CT and CP values as it is sequentially produced by the combustion model logic block 108 and to store the corresponding CT value in the memory location 112 only if it exceeds the current value stored in the memory location 112, and to store the corresponding CP value in the memory location 114 only if it exceeds the current value in the memory location 114. Thus, for each engine cycle processed by the engine cylinder and exhaust manifold model logic block 92, PCT will correspond to the peak cylinder temperature during that engine cycle and PCP will correspond to the peak cylinder pressure during that engine cycle.

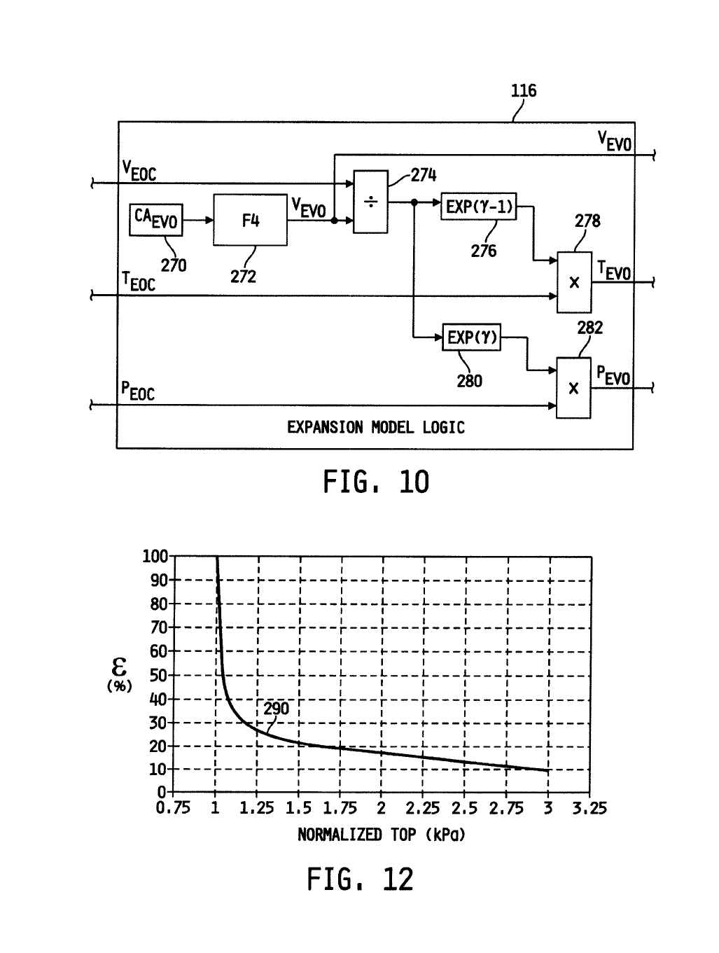

Referring now to FIG. 10, one illustrative embodiment of the expansion model logic block 116 is shown for embodiments of the engine cylinder and exhaust manifold logic 92 that include the expansion model logic. In the illustrated embodiment, the logic block 116 includes a memory block 270 that has a crank angle, CA_{EVO}, stored therein that is the crank angle at which the cylinder exhaust valve is opened (e.g., point F of the plot 94 of FIG. 3). Generally, CA_{EVO} will be known in advance for each cylinder and will typically be different for each of the L cylinders. CA_{EVO} is provided to an input of a function block 272 having the function F4 stored therein. Illustratively, the function F4 is provided in the form of equation (4) above, which processes CA_{EVO} to produce the cylinder volume, V_{EVO}, normalized by the clearance volume at CA=CA_{EVO}, and is provided as an output of the expansion model logic block 116 and also as the denominator input of a divide block 274. A numerator input of the divide block 274 receives the cylinder volume, V_{EOC}, normalized by the clearance volume at CA=CA_{EOC}, and the output of the divide block 274 is provided as an input to each of two different function blocks 276 and 280. The function block 276 illustratively has the function exp(γ−1) stored therein and the function block 280 illustratively has the function exp(γ) stored therein.

The output of the function block 276 is provided to one input of a multiplication block 278 having another input receiving the temperature value, T_{EOC}, corresponding to the operating temperature of the Kth cylinder at CA=CA_{EOC}. The output of the multiplication block 278 is the temperature, T_{EVO}, of the Kth cylinder at CA=CA_{EVO}, and is provided as an output of the expansion model logic block 116. In the illustrated embodiment, T_{EOC} is computed by the expansion model logic block 116 according to the equation:

$${T}_{EVO} = {T}_{EOC} \cdot {( \frac{{V}_{EOC}}{{V}_{EVO}} )}^{γ - 1} . \qquad ( 15 )$$

The output of the function block 280 is provided to one input of another multiplication block 282 having another input receiving the pressure value, P_{EOC}, corresponding to the operating pressure of the Kth cylinder at CA=CA_{EOC}. The output of the multiplication block 282 is the pressure, P_{EVO}, of the Kth cylinder at CA=CA_{EVO}, and is provided as an output of the expansion model logic block 116. In the illustrated embodiment, P_{EOC} is computed by the expansion model logic block 116 according to the equation:

$${P}_{evo} = {P}_{EOC} \cdot {( \frac{{V}_{EOC}}{{V}_{EVO}} )}^{γ} . \qquad ( 16 )$$

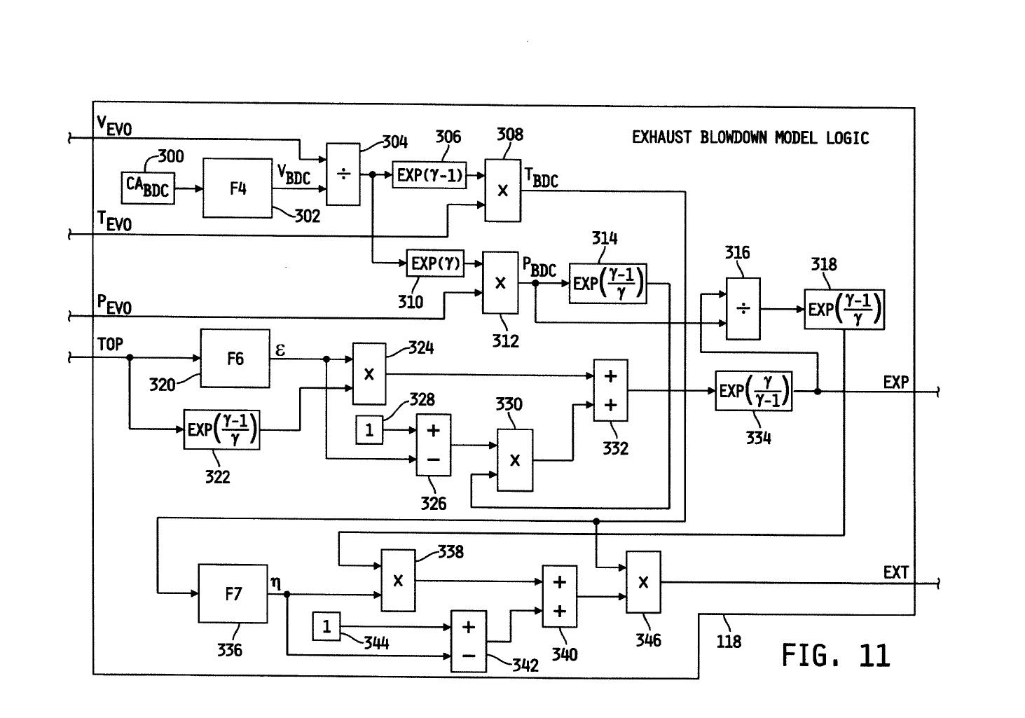

Referring now to FIG. 11, one illustrative embodiment of the exhaust blowdown model logic block 118 is shown for embodiments of the engine cylinder and exhaust manifold logic 92 that include the exhaust blowdown model logic. In the illustrated embodiment, the logic block 118 includes a memory block 300 that has a crank angle, CA_{BDC}, stored therein corresponding to the crank angle at which the cylinder piston is at bottom-dead-center. Generally, CA_{BDC} will be known in advance for each cylinder and will typically be different for each of the L cylinders. CA_{BDC} is provided to an input of a function block 302 having the function F4 stored therein. Illustratively, the function F4 is provided in the form of equation (4) above, which processes CA_{BDC} to produce the cylinder volume, V_{BDC}, normalized by the clearance volume at CA=CA_{BDC}, and is provided as the denominator input of a divide block 304. A numerator input of the divide block 304 receives the cylinder volume, V_{EVO}, normalized by the clearance volume at CA=CA_{EVO}, and the output of the divide block 304 is provided as an input to each of two different function blocks 306 and 310. The function block 306 illustratively has the function exp(γ−1) stored therein and the function block 310 illustratively has the function exp(γ) stored therein.

The output of the function block 306 is provided to one input of a multiplication block 308 having another input receiving the temperature value, T_{EVO}, corresponding to the operating temperature of the Kth cylinder at CA=CA_{EVO}. The output of the multiplication block 308 is the temperature, T_{BDC}, of the Kth cylinder at CA=CA_{BDC}, and in the illustrated embodiment, T_{BDC} is computed by the exhaust blowdown model logic block 118 according to the equation:

$${T}_{BDC} = {{T}_{EVO} ( \frac{{V}_{EVO}}{{V}_{BDC}} )}^{γ - 1} . \qquad ( 17 )$$

The output of the function block 310 is provided to one input of another multiplication block 312 having another input receiving the pressure value, P_{EVO}, corresponding to the operating pressure of the Kth cylinder at CA=CA_{EVO}. The output of the multiplication block 312 is the pressure, P_{BDC}, of the Kth cylinder at CA=CA_{BDC}, and in the illustrated embodiment, P_{BDC} is computed by the exhaust blowdown model logic block 118 according to the equation:

$${P}_{BDC} = {{P}_{EVO} ( \frac{{V}_{EVO}}{{V}_{BDC}} )}^{γ} . \qquad ( 18 )$$

The output, P_{BDC}, of the multiplication block 312 is provided to the input of another function block 314 illustratively having the function exp[(γ−1)/γ] stored therein, and is also supplied to a denominator input of a divide block 316.

The exhaust blowdown model logic block 118 further includes a function block 320 having a function F6 stored therein and an input receiving the turbine outlet pressure value, TOP. TOP is also supplied to an input of another function block 322 illustratively having the function exp[(γ−1)/γ] stored therein. The output of the function block 322 is provided to one input of a multiplication block 324.

The function F6 is illustratively configured to process the turbine outlet pressure value, TOP, and produce an efficiency value, ε, corresponding to a pressure-based exhaust blowdown efficiency. The exhaust blowdown model logic 118 generally computes the change in state variables of the cylinder charge from the CA=CA_{EVO} to exhaust manifold discharge. When the cylinder exhaust valve opens, the cylinder pressure is generally greater than the exhaust manifold pressure and a blowdown process thus occurs. In the ideal case, this blowdown occurs with the piston stationary at bottom-dead-center. During this blowdown process, the gas which remains inside the cylinder expands isentropically, and the gases escaping from the cylinder undergo an unrestrained expansion or throttling process which is irreversible. It is assumed that the kinetic energy acquired by each gas element as it is accelerated through the exhaust valve is dissipated in a turbulent mixing process in the exhaust port into internal energy and flow work. Since it is also assumed that no heat transfer occurs, the enthalpy of each element of gas after it leaves the cylinder remains constant.

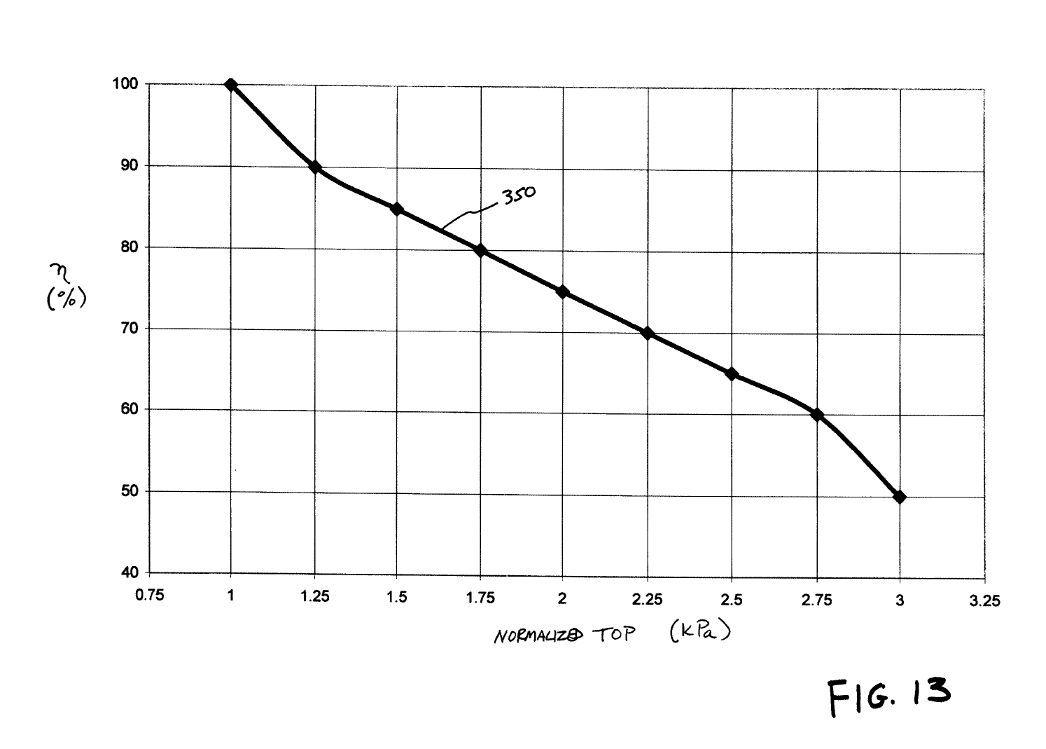

The exhaust blowdown model logic 118 computes the exhaust manifold pressure and exhaust manifold temperature using blowdown efficiency parameters (pressure and temperature-based) which characterize the deviation from the ideal exhaust blowdown process. The ideal exhaust blowdown process, as described above, consists of an isentropic expansion of the cylinder charge from exhaust valve opening to the bottom-dead-center, followed by a constant volume process at bottom-dead-center to atmospheric pressure or turbine outlet back pressure. The pressure-based exhaust blowdown efficiency, ε, produced by the function block 320 is illustratively the ratio of the indicated work done during isentropic expansion from the bottom-dead-center pressure to the exhaust manifold pressure to the indicated work done during isentropic expansion from the bottom-dead-center pressure condition to the turbine outlet or system back pressure. Referring to FIG. 12, a plot 290 is shown of one illustrative embodiment of the function F6 stored in the function block 320. The plot 290 defines the pressure-based exhaust blowdown efficiency, ε, plotted as a function of normalized turbine outlet pressure, TOP, and the control circuit 44 is operable to process the function F6 by normalizing the current turbine outlet pressure, TOP, and mapping the normalized TOP value to a corresponding value of E using the plot 290.

Referring again to FIG. 11, the pressure-based exhaust blowdown efficiency value, ε, produced by the function block 320 is provided as another input to the multiplication block 324 and also to a subtraction input of an arithmetic block 326. The output of the multiplication block 324 is provided to one input of a summation block 332. The value 1 is stored in a memory block 328, and is provided to an addition input of the arithmetic block 326 such that the output produced by the arithmetic block 326 is the quantity (1-ε), which is provided to one input of another multiplication block 330. Another input of the multiplication block 330 receives the output of the function block 314, and the output of the multiplication block 330 is provided to another input of the summation block 332. The output of the summation block 332 is provided as an input to another function block 334 illustratively having the function exp[(γ−1)/γ] stored therein. The output of the function block 334 is the exhaust manifold pressure value, EMP, which is produced as an output of the exhaust blowdown model logic block 118. In the illustrated embodiment, EMP is computed by the exhaust blowdown model logic block 118 according to the equation:

$$EMP = {[ ɛ \cdot {TOP}^{\frac{γ - 1}{γ}} + ( 1 - ɛ ) {P}_{BDC}^{\frac{γ - 1}{γ}} ]}^{\frac{γ}{γ - 1}} . \qquad ( 19 )$$

The exhaust manifold pressure value, EMP, is also provided to a numerator input of a divide block 316 having a denominator input receiving the pressure value, P_{BDC}, produced by the multiplication block 312. The output of the divide block 316 is provided to an input to another function block 318 illustratively having the function exp[(γ−1)/γ] stored therein. The output of the function block 318 is provided to an input to another function block 336 having a function F7 stored therein. Illustratively, the function F7 computes a temperature-based exhaust blowdown efficiency, η, as a function of the temperature, T_{BDC}, of the Kth cylinder at CA=CA_{BDC}, and may be stored in the form of a table, chart, graph, one or more equations, or the like. Alternatively, η may be stored in memory as a constant. Referring to FIG. 13, a plot 350 is shown of one illustrative embodiment of the function F7 stored in the function block 336. The plot 350 defines the temperature-based exhaust blowdown efficiency, η, plotted as a function of normalized turbine outlet pressure, TOP, and the control circuit 44 is operable to process the function F7 by normalizing the current turbine outlet pressure, TOP, and mapping the normalized TOP value to a corresponding value of η using the plot 350.

In any case, η is provided to one input of a multiplication block 338 and also to a subtraction input of an arithmetic block 342. Another input of the multiplication block 338 receives the output of the function block 318, and the output of the multiplication block 338 is provided to one input of a summation block 340. The value 1 is stored in a memory block 344, and is provided to an addition input of the arithmetic block 342 such that the output produced by the arithmetic block 342 is the quantity (1-η), which is provided to another input of the summation block 340. The output of the summation block 340 is provided to one input of a multiplication block 346 having another input receiving the temperature, T_{BDC}, of the Kth cylinder at CA=CA_{BDC}. The output of the multiplication block 346 is the exhaust manifold temperature value, EMT, which is produced as an output of the exhaust blowdown model logic block 118. In the illustrated embodiment, EMT is computed by the exhaust blowdown model logic block 118 according to the equation:

$$EMT = {T}_{BDC} \cdot [ 1 - η + η \cdot {( \frac{EMP}{{P}_{BDC}} )}^{\frac{γ - 1}{γ}} ] . \qquad ( 20 )$$

Referring again to FIG. 4, EMT and EMP produced by the exhaust blowdown model logic block 118 are illustratively stored in memory locations 120 and 122 respectively, and are also provided to the induction model logic block 102 as previous exhaust manifold temperature and pressure values respectively, i.e., exhaust manifold temperature pressure resulting from the operation of the Kth cylinder of the engine 12 during the previous engine cycle, for use in computing cylinder operating variables for the next engine cycle. The cylinder and exhaust manifold model logic 92 continually repeats all or at least some of the process just described to estimate, in one embodiment, peak cylinder temperature and/or peak cylinder pressure for the Kth cylinder during all aspects of engine operation, e.g., during transient and steady state engine operation. Alternatively or additionally, the cylinder and exhaust manifold model logic block 92 may continually repeat all or at least some of the process just described to estimate exhaust manifold pressure and/or exhaust manifold temperature based on operation of the Kth cylinder. Although not specifically shown in the drawings, the memory 46 may additionally have stored therein a separate engine cylinder and exhaust manifold logic block 92 for each of the K cylinders of the engine 12, and may further have instructions stored therein that are executable by the control circuit 44 to estimate exhaust manifold pressure and/or temperature based on EMP and EMT values produced by each of the K logic blocks 92. Such instructions may, for example, illustratively include a conventional weighted or unweighted averaging process for estimating exhaust manifold pressure and/or temperature based on the K different pairs of EMP and EMT, and any such instructions would be a mechanical step for a skilled circuit programmer.

While the invention has been illustrated and described in detail in the foregoing drawings and description, the same is to be considered as illustrative and not restrictive in character, it being understood that only illustrative embodiments thereof have been shown and described and that all changes and modifications that come within the spirit of the invention are desired to be protected.

What is claimed is:

1. A method for determining at least one physical property of exhaust gas produced by a cylinder of an internal combustion engine, the method comprising:
determining a temperature, T_{EOC}, a pressure, P_{EOC}, and a clearance volume, V_{EOC}, of the cylinder at an end of combustion of an engine cycle,
determining a temperature T_{EVO}, a pressure, P_{EVO}, and a clearance volume, V_{EVO}, of the cylinder at an opening of an exhaust valve of the cylinder following the end of combustion of the engine cycle as a function of T_{EOC}, P_{EOC}, and V_{EOC},
determining a value of the at least one physical property of the exhaust gas produced by the cylinder during the engine cycle as a function of T_{EOC}, P_{EOC}, and V_{EOC}, and
storing the value of the at least one physical property of the exhaust gas during the engine cycle in memory.

2. The method of claim 1 wherein the at least one physical property of the exhaust gas produced by the cylinder includes at least one of exhaust gas pressure and exhaust gas temperature.

3. The method of claim 1 wherein the engine includes an exhaust manifold fluidly coupled to an inlet of a turbine of a turbocharger,
and wherein determining a value of the at least one physical property further comprises determining the value of the at least one physical property of the exhaust gas produced by the cylinder during the engine cycle as a function of T_{EOC}, P_{EOC}, V_{EOC} and a pressure of the exhaust gas at an outlet of the turbocharger.

4. The method of claim 1 wherein the at least one physical property of the exhaust gas produced by the cylinder includes at least one of exhaust gas pressure and exhaust gas temperature.

5. The method of claim 1 further comprising:
processing an engine position signal produced by an engine position sensor to determine engine position relative to a reference engine position,
determining the temperature, T_{EOC}, a pressure, P_{EOC}, and a clearance volume, V_{EOC}, of the cylinder when the determined engine position corresponds to the end of the combustion cycle of the cylinder.

6. The method of claim 1 further comprising:
processing an engine position signal produced by an engine position sensor to determine engine position relative to a reference engine position, and
determining the temperature, T_{EVO}, the pressure, P_{EVO}, and the clearance volume, V_{EVO}, of the cylinder when the determined engine position corresponds to the opening of the exhaust valve following the end of the combustion cycle of the cylinder.

7. The method of claim 6 wherein processing the engine position signal to determine engine position comprises processing the engine position signal to determine a crank angle corresponding to an angle of a crankshaft of the engine relative to a reference crank angle,
and wherein the determined engine position corresponds to a crank angle, CA_{EVO}, at which the exhaust valve is opened,
and wherein determining the clearance volume, V_{EVO}, of the cylinder comprises determining V_{EVO} as a function of CA_{EVO}.

8. The method of claim 6 wherein determining the temperature, T_{EVO}, of the cylinder comprises determining T_{EVO} as a product of T_{EOC} and a function of a ratio of V_{EOC} and V_{EVO}.

9. The method of claim 6 wherein determining the pressure, P_{EVO}, of the cylinder comprises determining P_{EVO} as a product of P_{EOC} and a function of a ratio of V_{EOC} and V_{EVO}.

10. The method of claim 1 further comprising:
processing an engine position signal produced by an engine position sensor to determine engine position relative to a reference engine position, and
determining a clearance volume, V_{BDC}, of the cylinder when the determined engine position corresponds to a bottom-dead-center position of a piston in the cylinder following the opening of the exhaust valve in the combustion cycle of the cylinder.

11. The method of claim 10 wherein processing the engine position signal to determine engine position comprises processing the engine position signal to determine a crank angle corresponding to an angle of a crankshaft of the engine relative to a reference crank angle,
and wherein the determined engine position corresponds to a crank angle, CA_{BDC}, at which the piston is in the bottom-dead-center position,
and wherein determining the clearance volume, V_{BDC}, of the cylinder comprises determining V_{BDC} as a function of CA_{BDC}.

12. The method of claim 10 further comprising determining a temperature, T_{BDC}, of the cylinder when the piston in the bottom-dead-center position as a function of V_{EVO}, V_{BDC} and T_{EVO},
wherein the at least one physical property of the exhaust gas includes exhaust gas temperature,
and wherein determining a value of the at least one physical property of the exhaust gas produced by the cylinder during the engine cycle comprises determining the exhaust gas temperature as a function of T_{BDC}.

13. The method of claim 12 further comprising determining a pressure, P_{BDC}, of the cylinder when the piston in the bottom-dead-center position as a function of V_{EVO}, V_{BDC} and P_{EVO},
and wherein determining the exhaust gas temperature comprises determining the exhaust gas temperature as a function of T_{BDC} and P_{BDC}.

14. The method of claim 13 wherein the at least one physical property of the exhaust gas further includes exhaust gas pressure,
and wherein determining the exhaust gas temperature comprises determining the exhaust gas temperature as a function of T_{BDC}, P_{BDC} and the exhaust gas pressure.

15. The method of claim 10 further comprising determining a pressure, P_{BDC}, of the cylinder when the piston in the bottom-dead-center position as a function of V_{EVO}, V_{BDC} and P_{EVO},
wherein the at least one physical property of the exhaust gas includes exhaust gas pressure,
and wherein determining a value of the at least one physical property of the exhaust gas produced by the cylinder during the engine cycle comprises determining the exhaust gas pressure as a function of P_{BDC}.

16. The method of claim 15 wherein the engine includes an exhaust manifold fluidly coupled to an inlet of a turbine of a turbocharger,
and further comprising determining a pressure of the exhaust gas at an outlet of the turbine,
wherein determining the exhaust gas pressure as a function of P_{BDC} and the pressure of the exhaust gas at the outlet of the turbine.

17. A method for determining at least one physical property of exhaust gas produced by a cylinder of an internal combustion engine, the method comprising:
executing a combustion model that models changes in operating conditions of the cylinder throughout a combustion portion of an engine cycle, the combustion model estimating a temperature, T_{EOC}, and a pressure, P_{EOC}, of the cylinder at an end of the combustion portion of the engine cycle,
executing an expansion model that models changes in operating conditions of the cylinder between the end of the combustion portion of the engine cycle and a point thereafter in the engine cycle at which an exhaust valve of the cylinder is opened, the expansion model estimating cylinder temperature, T_{EVO}, and cylinder pressure, P_{EVO}, when the exhaust valve of the cylinder is opened as a function of T_{EOC} and P_{EOC},
executing an exhaust blowdown model that models changes in operating conditions of the cylinder between the point in the engine cycle at which the exhaust valve of the cylinder is opened and a point thereafter in the engine cycle at which a piston reaches a bottom-dead-center position in the cylinder, the exhaust blowdown model estimating a value of the at least one physical property of the exhaust gas produced by a cylinder as a function of T_{EVO} and P_{EVO}, and
storing the value of the at least one physical property of the exhaust gas produced by a cylinder in memory.

18. The method of claim 17 wherein the combustion model further estimates a clearance volume, V_{EOC}, of the cylinder at the end of combustion of the engine cycle, wherein the expansion model estimates T_{EVO}, P_{EVO} and a clearance volume, V_{EVO}, of the cylinder at the point in the engine cycle at which the exhaust valve of the cylinder is opened as a function of T_{EOC}, P_{EOC} and V_{EOC},
and wherein the exhaust blowdown model estimates the value of the at least one physical property of the exhaust gas produced by a cylinder as a function of T_{EVO}, P_{EVO} and V_{EVO}.

19. The method of claim 18 wherein the engine includes an exhaust manifold fluidly coupled to an inlet of a turbine of a turbocharger,
and further comprising determining a pressure of the exhaust gas at an outlet of the turbine,
wherein the exhaust blowdown model estimates the value of the at least one physical property of the exhaust gas produced by a cylinder as a function of T_{EVO}, P_{EVO}, V_{EVO} and the pressure of the exhaust gas at the outlet of the turbine.

20. The method of claim 17 wherein the at least one physical property of the exhaust gas includes at least one of a temperature of the exhaust gas produced by the cylinder and a pressure of the exhaust gas produced by the cylinder,
and wherein the exhaust blowdown model estimates a value of the at least one of the temperature of the exhaust gas produced by the cylinder and the pressure of the exhaust gas produced by the cylinder as a function of T_{EVO}, P_{EVO} and V_{EVO}.
